(19) United States
(12) Patent Application Publication
(10) Pub. No.: US 2013/0339238 A1
(43) Pub. Date: Dec. 19, 2013

(54) Manufacturer-Based Purchase Transaction Benefit Processing

(71) Applicants: Judith M. Unland, Elmhurst, IL (US); Timothy F. McMahon, Cincinnati, OH (US)

(72) Inventors: Judith M. Unland, Elmhurst, IL (US); Timothy F. McMahon, Cincinnati, OH (US)

(73) Assignee: JJ&T Holdings LLC, Bonita Springs, FL (US)

(21) Appl. No.: 13/524,905

(22) Filed: Jun. 15, 2012

(51) Int. Cl. G06Q 30/06

(52) U.S. Cl. 705/44

(57) ABSTRACT

A method of facilitating a purchase transaction includes receiving an authorization request message that includes a consumer account code for a consumer, a manufacturer identification code for a manufacturer, a product identification code for a respective product associated with the manufacturer, and pricing data for the respective product. The consumer account code and the manufacturer identification code are obtained by a merchant from the consumer via an instrument presented by the consumer to the merchant during the purchase transaction. The respective product is identified at the merchant by filtering a plurality of products based on the manufacturer identification code. A memory in which program data is stored is accessed. The program data specifies a program factor for the manufacturer. A fund amount to be applied in connection with the purchase transaction is determined based on the program data and data in the authorization request message.

### BACKGROUND OF THE DISCLOSURE

1. Field of the Disclosure

The disclosure relates to product transactions between consumers and merchants and, more particularly, to product transactions involving presentation of an instrument, such as a loyalty or payment card, by the consumer to facilitate the product transaction.

2. Brief Description of Related Technology

Manufacturers distribute coupons to drive sales of their products. Each coupon provides a one-time discount for a consumer. Consumers often obtain coupons from a newspaper or flyer. A consumer then takes the coupon to a merchant, selects a product for purchase, and brings the product and the coupon to a cashier. The cashier checks the coupon against the product. If the coupon and the product match, the merchant treats the coupon as cash toward the purchase of the product, and the consumer can pay a reduced amount for the product. The merchant then requests reimbursement from the manufacturer. Upon confirming the validity of the coupon and the amount, the manufacturer pays the merchant the face value of the coupon plus a predetermined amount for handling the coupon. The manufacturer has thus discounted the price of the product to the consumer.

The merchant sends the used coupons to a clearinghouse, which then sends a request to the manufacturer for payment. After processing and verification, the manufacturer sends payment to the merchant. This process often takes one or more months to complete, and is prone to fraud and error.

Couponing is often very ineffective and inefficient for the manufacturer and merchant. The manufacturer may print millions of coupons but only see a small fraction redeemed. The manufacturer receives no information regarding the consumer redeeming the coupon. The manufacturer is unable to discern consumer-specific purchase patterns, such as repeat buys of the product, quantity purchased, purchase frequency, and related purchases. The manufacturer often has limited information on when the purchase was made, the price paid, and may not know the specific item purchased. The merchant has significant expense in handling and redeeming the coupon, including contracts with the clearinghouses or other middlemen to process the coupons.

Electronic coupons (e-coupons) and mobile coupons (m-coupons) eliminate the need to print or obtain paper coupons, but also present disadvantages for manufacturers. A consumer creates an account at a merchant or at an aggregator site and selects or receives coupons that are then loaded to loyalty cards associated with the merchant. When redeemed by the consumer at a point-of-sale (POS) site, the manufacturer receives little, if any, information from the merchant regarding the sale. E-coupons and m-coupons also suffer from stacking issues. Stacking occurs when a POS system allows both an e-coupon (or an m-coupon) and a standard printed coupon to be redeemed for the same item, forcing the manufacturer to pay twice. In addition, e-coupons and m-coupons may be copied or distributed via the Internet inappropriately.

Payment cards, including prepaid gift cards and rebate cards, are issued for use at a specified merchant (e.g., proprietary cards, such as Macy's, Sears, Target, etc.) on a closed loop network or at multiple merchants when they are issued by a financial institution on a payment network (e.g. Visa, MasterCard, American Express, Discover) on an open loop network. Proprietary card issuers often offer discounts, incentives and rewards for using their card. Issuers of open loop payment cards often offer rewards based on frequent use of the cards. These cards promote loyalty to purchase items at the specified merchant or to use a specified card for payment when making purchases.

Several types of loyalty and incentive programs exist that encourage the consumer to transact at specified merchants or to choose a certain payment card for transactions. These programs are based on various premises, including membership clubs (such as Sam's Club, AAA, etc.), specified merchant cards (such as closed loop cards, open loop cards that filter by merchant), and frequent use of a card for payment.

### SUMMARY OF THE DISCLOSURE

In accordance with one aspect of the disclosure, a method is useful for facilitating a purchase transaction between a consumer and a merchant for a plurality of products, a respective product of which is associated with a manufacturer. The method includes receiving, during the purchase transaction, from the merchant via a communication network, an authorization request message for the purchase transaction. The authorization request message includes a consumer account code for the consumer, a manufacturer identification code for the manufacturer, a product identification code, and pricing data for the respective product. The consumer account code and the manufacturer identification code are obtained by the merchant from the consumer via an instrument presented by the consumer to the merchant during the purchase transaction, and the respective product is identified at the merchant by filtering the plurality of products based on the manufacturer identification code. The method further includes accessing a memory in which program data is stored, the program data specifying a program factor for the manufacturer, determining, with a processing device, a fund amount to be applied in connection with the purchase transaction based on the program data and data in the authorization request message, and sending, during the purchase transaction, to the merchant via the communication network, an authorization response message regarding application of the determined fund amount.

The program factor may include a rule specifying a criterion for qualifying for a transaction benefit. Alternatively or additionally, the program factor includes a rule specifying a calculation for quantifying a transaction benefit.

Determining the fund amount may be further based on an available account balance. Alternatively or additionally, determining the fund amount is further based on consumer demographic data.

The method may further include storing data indicative of the purchase transaction in a transaction history database. Determining the fund amount may then further include analyzing past transaction data stored in the transaction history database regarding a previous purchase transaction involving the consumer.

The method may further include transferring funds by debiting a first settlement account associated with the manufacturer or a payment card in an amount that corresponds with the determined fund amount, crediting a second settlement account associated with a merchant, a charity or an individual in an amount that corresponds with the determined fund amount, and recording settlement transactions in a funds settlement database.

The instrument may be a loyalty card for one or more manufacturers. Alternatively or additionally, the instrument is a payment card.

In accordance with another aspect of the disclosure, a non-transitory computer-readable medium has stored therein data representing instructions executable by a programmed processing device for facilitating a purchase transaction between a consumer and a merchant for a plurality of products, a respective product of which is associated with a manufacturer. The instructions include computer code to receive product information regarding the plurality of products during the purchase transaction, receive a consumer account code for the consumer and a manufacturer identification code for the manufacturer via an instrument presented by the consumer to the merchant during the purchase transaction, identify the respective product of the plurality of products by filtering the product information based on the manufacturer identification code, generate an authorization request message including the consumer account code, the manufacturer identification code, a product identification code for the respective product, and pricing data for the respective product, send the authorization request message via a communication network to a system of a manufacturer agent during the purchase transaction, receive, during the purchase transaction from the system of the manufacturer agent via the communication network, an authorization response message regarding a fund amount to be applied to the purchase transaction, the fund amount being determined based on a program factor for the manufacturer and further based on the consumer account code, and apply the fund amount to the purchase transaction.

The instructions may include further computer code to implement a settlement of funds to a merchant account.

The instructions may include further computer code to receive a department code, a family code, or a product code via the instrument. The instructions to identify the respective product may be further based on the department code, the family code, or the product code.

In accordance with another aspect of the disclosure, a non-transitory computer-readable medium has stored therein data representing instructions executable by a programmed processing device for facilitating a purchase transaction between a consumer and a merchant for a plurality of products, a respective product of which is associated with a manufacturer. The instructions include computer code to receive, during the purchase transaction, from the merchant via a communication network, an authorization request message for the purchase transaction. The authorization request message includes a consumer account code for the consumer, a manufacturer identification code for the manufacturer, a product identification code, and pricing data for the respective product. The consumer account code and the manufacturer identification code are obtained by the merchant from the consumer via an instrument presented by the consumer to the merchant during the purchase transaction. The respective product is identified at the merchant by filtering the plurality of products based on the manufacturer identification code. The instruction include further computer code to access a memory in which program data is stored, the program data specifying a program factor for the manufacturer, determine, with a processing device, a fund amount to be applied in connection with the purchase transaction based on the program data and data in the authorization request message, and send, during the purchase transaction, to the merchant via the communication network, an authorization response message regarding application of the determined fund amount in connection with the purchase transaction.

The program factor may include a rule specifying a criterion for qualifying for a transaction benefit. Alternatively or additionally, the program factor includes a rule specifying a calculation for quantifying a transaction benefit. Alternatively or additionally, the program factor includes a rule specifying a use frequency criterion for qualifying for a purchase transaction benefit. Alternatively or additionally, the program factor includes a rule requiring multiple products in a purchase transaction. Alternatively or additionally, the program factor includes a rule based on consumer demographic information.

The instructions to determine the fund amount may include further instruction to determine the fund amount based on an available account balance.

The instructions may include further computer code to store data indicative of the purchase transaction in a transaction history database. The instructions to determine the fund amount may include further instructions to analyze past transaction data stored in the transaction history database regarding a previous purchase transaction involving the consumer.

The instructions may include further computer code to transfer funds by debiting a settlement account associated with the manufacturer or a payment card in an amount that corresponds with the determined fund amount, crediting a settlement account associated with a merchant, a charity or an individual in an amount that corresponds with the determined fund amount, and recording the settlement transactions in a funds settlement database.

In accordance with yet another aspect of the disclosure, a system facilitates a purchase transaction between a consumer and a merchant for a plurality of products, a respective product of which is associated with a manufacturer. The system includes a merchant data collection system configured to obtain product information regarding the plurality of products during the purchase transaction and to further obtain a consumer account code for the consumer and a manufacturer identification code for the manufacturer via an instrument presented by the consumer to the merchant during the purchase transaction, a merchant processing system including a filter module configured to identify the respective product of the plurality of products by filtering the product information based on the manufacturer identification code, an authorization request and response module configured to generate, for transmission via a communication network, an authorization request message including the consumer account code, the manufacturer identification code, a product identification code for the respective product, and pricing data for the respective product, and being further configured to receive an authorization response message including a fund amount or a discount to be applied in connection with the purchase transaction, and a funds module configured to apply the fund amount or the discount in connection with the purchase transaction. The system further includes a memory in which program data is stored, the program data specifying program rules, criteria and factors for the manufacturer. The system further includes a manufacturer agent processing system in communication with the memory and in communication with the merchant processing system via the communication network to receive the authorization request message, the manufacturer agent processing system being configured to determine the fund amount or the discount to be applied in connection with the purchase transaction based on the program data and data in the authorization request message, and being further configured to send an authorization response message during the purchase transaction to the merchant via the communication network regarding application of the determined fund amount.

The manufacturer agent system may store consumer demographic data. The manufacturer agent processing system may be further configured to analyze the demographic data in determining the fund amount or the discount to apply in connection with the purchase transaction.

The manufacturer agent system may include a transaction history database in which data indicative of the purchase transaction is stored. The manufacturer agent processing system may be further configured to analyze past transaction data stored in the transaction history database regarding a previous purchase transaction involving the consumer.

The manufacturer agent system may include a funds settlement database in which data indicative of transferring funds related to the purchase transaction is stored. The manufacturer agent processing system may be further configured to debit a settlement account associated with the manufacturer or a payment card in an amount that corresponds with the fund amount in connection with the purchase transaction, credit a settlement account associated with a merchant, a charity or an individual in an amount that corresponds with the fund amount applied in connection with the purchase transaction, and record the settlement transactions in a funds settlement database.

The system may further include a manufacturer program system configured to facilitate a consumer selection of one or more manufacturer preference programs, products of a specific manufacturer, or an instrument type.

The system may further include a manufacturer program system operable to configure program factors applicable to authorization requests from a plurality of merchant systems.

The program data may include a plurality of rules, the plurality of rules including a demographic rule, a historical transaction rule, a current transaction rule, and an account information rule.

### BRIEF DESCRIPTION OF THE DRAWING FIGURES

For a more complete understanding of the disclosure, reference should be made to the following detailed description and accompanying drawing figures, in which like reference numerals identify like elements in the figures.

FIG. 1 is a flow diagram of an overview of a manufacturer preference purchase transaction benefit program configured in accordance with an exemplary embodiment.

FIG. 2 is a flow diagram of a process for establishing the specifications of the manufacturer preference purchase transaction benefit program (such as a program type) in accordance with one embodiment.

FIG. 3 is a flow diagram of a process for establishing one or more aspects of the manufacturer preference purchase transaction benefit program at a merchant participating in the manufacturer preference purchase transaction benefit program in accordance with one embodiment.

FIG. 4 is a flow diagram of a process for establishing one or more aspects of the manufacturer preference purchase transaction benefit program with a consumer participating in the manufacturer preference purchase transaction benefit program in accordance with one embodiment.

FIGS. 5 and 6 are flow diagrams of a method of facilitating a purchase transaction between a consumer and a merchant via a manufacturer preference purchase transaction benefit program in accordance with an exemplary embodiment.

FIG. 7 is a flow diagram of a settlement process of a manufacturer preference purchase transaction benefit program for use with the method of FIGS. 5 and 6 in accordance with one embodiment.

FIG. 8 is a schematic representation of an exemplary front-end or merchant-side filtering process of the method of FIGS. 5 and 6 in accordance with one embodiment.

FIG. 9 is a schematic representation of an exemplary authorization request message generated in connection with the filtering process of FIG. 8 in accordance with one embodiment.

FIG. 10 is a schematic representation of exemplary program and transaction history data and processing of the authorization request message by the manufacturer agent in accordance with one embodiment.

FIG. 11 is a flow diagram of one or more methods of, or computer-readable media instructions for, facilitating a purchase transaction between a consumer and a merchant in accordance with an exemplary embodiment.

FIG. 12 is a block diagram of a system for facilitating a purchase transaction between a consumer and a merchant in accordance with one embodiment.

While the disclosed methods, systems, and computer-readable media are susceptible of embodiments in various forms, illustrated in the drawing (and will hereafter be described) are specific embodiments of the invention, with the understanding that the disclosure is intended to be illustrative, and is not intended to limit the invention to the specific embodiments described and illustrated herein.

### DETAILED DESCRIPTION OF THE DISCLOSURE

Methods, systems, and computer-readable media are described to support manufacturer-based purchase transaction benefits provided to consumers. In one aspect, the disclosed methods, systems, and computer-readable media apply manufacturer-based filtering functionality to a purchase transaction. The filtering is based on one or more manufacturers and one or more products of the manufacturer(s) selected for purchase at a point-of-sale (POS) merchant site. The manufacturer(s) may be identified at the POS site via an instrument presented by the consumer, such as a plastic card with a magnetic stripe or barcoded tag(s), a smart card with PIN and chip or NFC, or another device containing manufacturer and account information. Other information, such as a program type (e.g., loyalty, payment (credit, debit or prepaid, including, for instance, gift, rebate, incentive) and/or other discount or benefit information), may be identified via the account number assigned to the consumer. Regardless of the nature of the instrument, the filtering functionality analyzes data indicative of each item being purchased by a consumer to determine those items made by the manufacturer(s) identified by the instrument presented by the consumer.

One or more aspects relate to the transmission of data indicative of consumer purchase transactions involving products from one or more manufacturers from the merchant to an agent of the manufacturer (e.g. a processor) and/or repository. Once transmitted, such consumer purchase transaction data may be aggregated, analyzed, stored, and otherwise processed by the manufacturer(s) or its agent or representative. The transmission of the consumer purchase data may allow the processing of such data for purchase benefit determinations at the manufacturer agent system, rather than at the POS site or on other merchant equipment. With the processing at the manufacturer agent system, detailed program specifications and data need not be maintained at each POS site or on other merchant equipment.

One or more aspects of the disclosed methods, systems, and computer-readable media provide manufacturer-based purchase transaction benefit processing and technology at a manufacturer agent in real-time during the purchase transaction. The disclosed processing may calculate loyalty or other benefit calculations (including, for instance, determining if the balance of funds on a payment card exceeds purchase amount) on a system operated by the manufacturer agent. Such processing at the manufacturer agent may allow the manufacturer to flexibly configure (or re-configure) the factors of the manufacturer preference program. The program factors may include a variety of rules and criteria, including those relating to demographic information, historical and current transaction information (such as pricing, quantity, frequency, dates, amount spent, etc.) and account information. For example, a program may specify that a consumer purchasing $10 of manufacturer products every week for three weeks, receives $1 off each subsequent week's $10 purchase. Such processing allows benefits of much greater sophistication and complexity than, for instance, offering a single discount on a product purchase price. In another example, a consumer purchasing four manufacturer products in a specified product family receives an offer to obtain a fifth product for free during the first week of the month. Such program configuration reduces, minimizes, or eliminates extra programming or other configuration of each merchant system that sells the specific products of the manufacturer, such as the POS system. Such program configuration is under the programmatic control of the manufacturer agent, leading to a wide variety of loyalty or other program offers and discounting possibilities, and the creation and processing of much more complex or customized offers, which may further boost consumer loyalty.

The allocation of filtering and purchase benefit calculation processing functionality between the POS (e.g., frontend) and the manufacturer agent equipment may provide a number of advantages in spite of the distributed or non-local nature of the benefit processing functionality. After the filtering is completed, the POS or frontend site sends a list of the manufacturer products being purchased, the prices to be paid, and the consumer's preference program account number to the manufacturer agent processing system. Filtering at the POS site minimizes or reduces the amount of data transmitted to the manufacturer agent processing system. For example, data indicative of all products to be purchased need not be transmitted. The processing system calculates or otherwise determines a benefit based on the transmitted information provided as described elsewhere. Even though the manufacturer agent is remote from the POS site, the processing system of the manufacturer agent responds in real-time to the merchant so that a program benefit (e.g., a discount amount, funds applied toward purchase amount) is specified during the transaction. The merchant and consumer know at the POS site how much the manufacturer is to pay on behalf of the consumer. Notwithstanding the foregoing, the filtering and other processing described herein may be implemented remotely or in any combination of local and distributed processing.

The manufacturer preference program may also include payment cards. Like the loyalty cards, the payment cards are not limited to use at a specified merchant on a closed loop network of the merchant. The payment cards may be used on an open loop network, via the payment networks maintained by, for example, Visa, MasterCard, American Express, Discover, or on a closed loop network, via direct connections between the merchant and the manufacturer agent.

The disclosed methods, systems, and computer-readable media may be used in connection with other payment types, such as prepaid cards (e.g. incentive, rebate and gift), benefit cards, and credit and debit cards. For example, the processing described enables manufacturer-specific rebate and incentive cards as well as manufacturer-specific gift cards that restrict the use of the cards to future purchases of only specified products of the manufacturer. These offers may be used to expand consumer relationships, improve knowledge, feedback and understanding of consumer behavior, enable more sophisticated and targeted marketing campaigns and offers, and/or drive increased revenue and profitability of their products and loyalty for their brands. These offers are not burdened by the constraints and inconveniences of other mechanisms, such as completing and mailing paperwork for rebates and other offers. These offers also provide greater control and flexibility for the manufacturer. For example, the disclosed methods, systems, and computer-readable media may be configured to target one or more particular products or product lines of the manufacturer or allow any of the products of the manufacturer to qualify for a program benefit. A variety of other circumstances or conditions of interest to the manufacturer may be targeted for driving loyalty and additional revenue.

One or more aspects of the disclosed methods, systems, and computer-readable media address the limitations of coupon-based techniques and the inability to associate a manufacturer to a payment instrument. As consumers use their manufacturer loyalty card or other payment instrument, the manufacturer may receive data on when, where and who used the instrument, as well as the manufacturer products purchased and the prices paid. Useful consumer-specific purchase data may thus be generated (as opposed to aggregated sales data). Such consumer-specific data may be mined or otherwise analyzed for insight into consumer behavior. For example, the data generated by each manufacturer preference purchase transaction may be provided to analytic models maintained by the manufacturer, improving the models and enabling calculation of repeat buys, frequency of buying, quantities purchased each visit, and other consumer behavior insights. Consumer models and marketing campaigns may thus be created. The data generated by the program makes possible more robust and detailed analysis, thereby facilitating one-on-one relationships between the consumer and manufacturer.

One or more aspects of the disclosed methods, systems, and computer-readable media allow the manufacturer to establish a direct relationship with the consumer. Significant consumer loyalty for the manufacturer may be generated. For example, the instrument may be presented at a wide variety of merchants, unlike typical membership and loyalty cards issued to consumers for purchasing merchandise or services from a particular merchant. Notwithstanding the foregoing, other reasons may underlie the manufacturer preference program, including, for instance, government-sponsored programs or initiatives.

The disclosed methods, systems, and computer-readable media are not limited to a particular type of POS system. The manufacturer preference cards or other instruments may be used at any POS system. The configuration of the POS system may use data, instruction sets, software, firmware, hardware, or other system components that already exist within the POS system.

The disclosed methods, systems, and computer-readable media provide techniques to pass certain information to qualify the transaction for the manufacturer preference program. For example, instruments used for a manufacturer preference program contain a unique account number that is associated with the consumer. These numbers may be provided at the time of a transaction to verify that the account number is active and valid. Data to determine when an incentive, discount, award, or other benefit is earned at the POS site may thus be tracked on a consumer-by-consumer basis. Additionally, in payment card embodiments, the manufacturer agent processing systems associated with the payment card may then track the use of the card, qualifying transactions (e.g., products being purchased meet the parameters of the manufacturer preference program), and determining if the account balance equals or exceeds the qualifying purchase amount.

As described elsewhere, in some embodiments, the manufacturer preference account information is combined with the manufacturer and product information to facilitate the purchase transaction and the program benefit determination. During the transaction, the manufacturer and product information is communicated to the POS terminal in order to identify manufacturer merchandise being purchased. A merchant system or device may generate and send an authorization request message identifying merchandise being purchased from the specified manufacturer(s) along with the account (e.g., card) information. The authorization request message is passed or otherwise transmitted to the manufacturer agent (e.g., a processor) to verify that the card is valid and that any number of criteria (e.g. factors) are met regarding the manufacturer(s) and products. The manufacturer agent (e.g. processor) responds to the authorization request identifying whether or not the consumer receives a discount (e.g. funds applied towards the purchase) or, if the program type is a payment instrument, the amount of the payment account balance applied to the purchase.

The use of a manufacturer agent (e.g. processor) for the manufacturer(s) preference calculation (or other determination) may centralize several aspects of the process. For example, configuration of the calculation processing is only implemented at the manufacturer agent end rather than at each POS site. Such calculation configuration becomes available at any merchant POS site at which the program cards or other instruments are accepted. Subsequent program changes, such as a new offer determination process, do not need to be programmed and tested at each of the many different merchants and POS systems. In contrast, the configuration of the POS terminal, register, or other POS device or data collection system is a one-time project to enable the manufacturer-based filtering and authorization request and response message processing.

In some cases, the disclosed methods, systems, and computer-readable media are applied to provide improved or more sophisticated offers. Such offers may be issued one-by-one by a manufacturer to a specific member of the manufacturer preference program. By providing offers based on the consumer preference account code in addition to a manufacturer number and item code, the processing may provide one or more benefits over conventional coupons, including, (i) the manufacturer receives feedback (e.g., usage data) when offers are accepted, and (ii) issuing offers to specific consumers in the program based on consumer profiles (e.g., past purchase history, program factors and data, analytics results, etc.). In these and other ways, the manufacturer is able to efficiently and effectively target their marketing campaigns and receive feedback based on the offers processed. The disclosed methods, systems, and computer-readable media may incorporate a variety of aspects into the offers, such as a purchase history of a consumer, product bundles, purchase frequency, minimum spending levels over a period of time, precise usage scenarios, conditional expirations, product family-based qualifications, variable discounts with each use within a time period, and variable mystery discounts (e.g., free for every tenth purchaser). The nature of such usage control techniques may vary considerably.

The real-time processing aspect of the disclosed methods, systems, and computer-readable media may provide further advantages. For example, manual coupon handling expenses and middleman contract hassles may be eliminated. The long wait typically endured by a merchant to receive payment from the manufacturer for each coupon redemption may also be avoided. These and other advantages are available due to the timely nature of the processing.

Manufacturer preference program instruments (e.g., cards) may be used with a wide variety of merchants, as well as the POS and other systems and devices thereof. As described below, the merchant may be configured to accept the instruments by establishing a relationship with the manufacturer or manufacturer agent, such as an agent that represents one or multiple manufacturers. The disclosed methods, systems, and computer-readable media may be used at a variety of POS sites, including, for instance, brick-and-mortar merchants, e-commerce websites, and mobile phone apps. In each case, the manufacturer preference program includes real-time processing to facilitate the product transaction. As described below, settlement payment processing from the manufacturer to the merchant may also be implemented in real-time at the time of sale, but alternatively may be batch processed at a later date and time.

The disclosed methods, systems, and computer-readable media are not limited to any specific type of manufacturer or product. The manufacturer may be any source of goods or services or other items being purchased. The products need not be goods or other physical items. The product may be virtual, and may be any combination of any number of goods and services. Moreover, the cards or other instruments presented by the consumer may identify one or multiple manufacturers and/or multiple manufacturer preference programs for a specific consumer.

The disclosed methods, systems, and computer-readable media are not limited to providing benefits directly to the consumer or as discounts to the purchase transaction. Benefits may be applied to the transaction to the consumer indirectly, such as through a subsequent transaction. Other benefits applied in connection with the transaction need not be directed to the consumer. Examples of such benefits include charitable donations by manufacturers. Consumers may thus avoid having to send boxtops or other proof of purchase for these and other program benefits, as the benefits are accumulated electronically. The manufacturer preference program may establish consumer or preference groups for school fundraisers, and tally total sales of the manufacturer products purchased by that consumer or preference group. In these examples, the purchase of manufacturer products may result in the manufacturer (or a representative or agent) donating a fixed or proportional amount of the product purchase to the school or other charity. Other examples of indirect benefits may include disaster relief cards distributed by the manufacturer.

Although described below in connection with consumer cards, such as payment (e.g., credit, debit, prepaid-gift, incentive, rebate), loyalty and other cards, the construction, configuration, and other characteristics of the instrument presented by the consumer may vary. The disclosed methods, systems, and computer-readable media are well suited for use with a wide variety of consumer instruments. The instrument need not be embodied in a card, but rather may be an electronic instrument, a virtual instrument, an e-wallet, or other device that stores the information described below. The instrument may be embedded in or carried by a mobile telephone, PIN and Chip card, plastic with barcode, NFC or other handheld device. The instrument contains account information and manufacturers preference of the consumers. For these and other reasons, the disclosed methods, systems, and computer-readable media are not limited to any particular type of consumer device or other instrument.

A consumer may include an individual, a business, or any other organization. A manufacturer agent may include a processor or a third party processor. A program may include, specify, or contain the details such as the account type issued (payment card, loyalty card or other type of card) and the factors applied. An account may identify the record associated with the consumer and may include purchase history, consumer demographic information and fund information. A transaction benefit may include funds that may be applied to the transaction (via payment card or discount) or other award. A network may include a communication link to connect parties of the transaction.

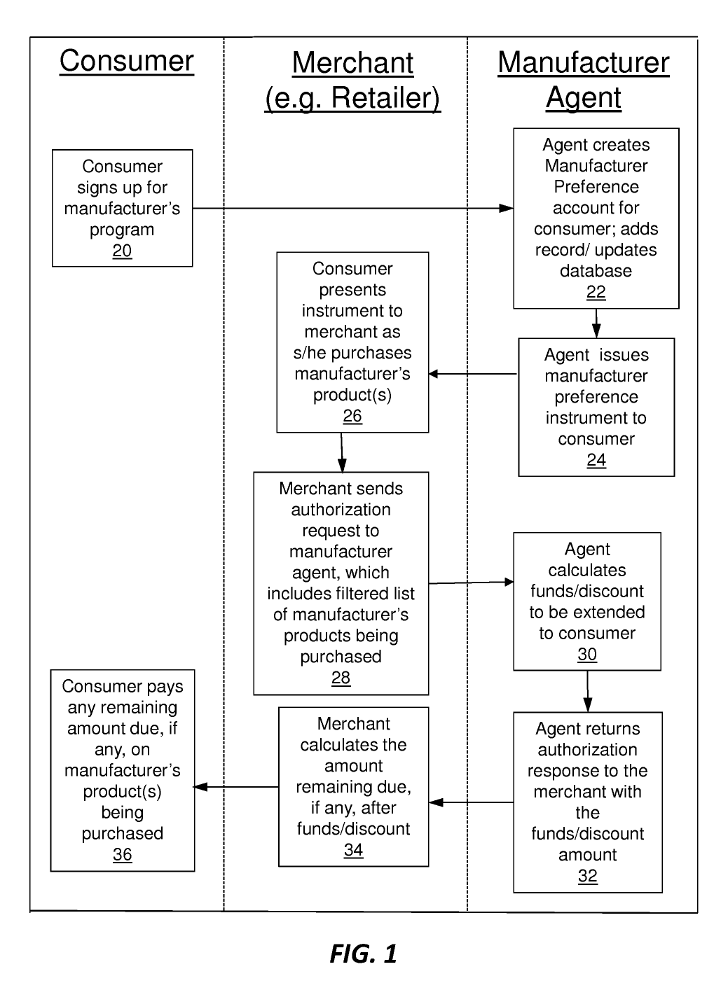

With reference now to the drawing figures, FIG. 1 provides an overview of an example of a manufacturer preference program. The overview depicts the use and application of one or more aspects of the manufacturer preference program. Details regarding the configuration or setup of the manufacturer preference program are set forth in connection with other figures. The consumer elects to participate in the manufacturer preference program in act 20. The election may involve a registration and/or application process, an example of which is described below. The program may be affiliated or associated with one or more manufacturers. The manufacturer or an agent or representative of the manufacturer creates a loyalty or other account for the consumer in act 22. Creation of the account may include adding a record to a database of consumer accounts. The account may be assigned an account number used to identify the consumer. In act 24, the manufacturer agent issues a manufacturer preference card or other instrument to the consumer, the card or other instrument being linked to the account. The consumer may then use the card or instrument in purchasing goods and/or services from a variety of merchants (including, for instance, retailers or service providers) at which the products of the manufacturer(s) are sold. There are several types of programs that may be used to indicate the preference of the cardholder, such as a prepaid incentive card, a prepaid rebate card, a prepaid gift card, or a loyalty card that applies account funds or offers discounts at a POS site. Based on the type of card or instrument, the consumer account may be held or managed by a financial institution.

The consumer subsequently wishes to purchase several items from a merchant. The merchant may include a brick and mortar store visited by the consumer, such as a grocery or general retail store. The merchant may alternatively be located remotely, and accessed by the consumer via the telephone, internet, or any other communication medium. The consumer may select any number of items for purchase. The items may be from any number of manufacturers. Upon selecting all of the merchandise for purchase, the consumer presents the card or other instrument in act 26 to the merchant during a purchase transaction of one or more products from the specified manufacturer(s). The merchant may have an input device or other data collection system at a POS terminal or site, such as a bar code reader, magnetic stripe reader, near field communications (NFC) or radio frequency identification (RFID) reader, computer or other terminal or other device capable of receiving or capturing information from the card or other instrument. By scanning or otherwise reading the instrument at the POS site, the data collection system of the merchant receives the manufacturer identification code(s) of the manufacturer(s) selected by the consumer for the program, as well as the consumer account code for the consumer. A wide variety of information may be captured by the data collection system, including, for instance, an account number, a card (instrument) expiration date, etc. In addition, the merchant may use the product scanner of the POS system to scan all merchandise being purchased, capturing for each item the product ID, manufacturer ID and quantity.

Based on the information gathered from the card or instrument and the product scanner, the merchant then generates and sends in act 28 an authorization request message to the manufacturer agent processing system for the program. The authorization request message includes a list of the manufacturer's products being purchased. The products may be identified by a product code, such as a UPC code. The list of such products may be generated via a filtering process based on the manufacturer code and possibly, a department or family or product code. In this way, the POS device or system of the merchant identifies the one or more products being purchased that are made by the manufacturer(s) read from the instrument. The authorization request message also includes one or more manufacturer identification codes that specify the manufacturer(s) identified by the card or instrument presented by the consumer. The authorization request message further identifies the consumer via the consumer account code and also identifies the merchant. In some cases, the authorization request message may also identify the quantities and prices of the products being purchased.

The authorization request message may be transmitted over a transaction network, which may be operated in connection with a network operator such as Visa, MasterCard, American Express or Discover, or by another network that links the merchant to the manufacturer agent of the card or a direct link between the merchant and the processor of the card. The nature, operator, and other characteristics of the transaction network may vary. For example, in some embodiments, the transaction network may include a second network to transmit the transaction from a network operator (Visa, MasterCard, American Express or Discover) to the processor of the card.

The processing of the authorization request message may thus occur at a site located remotely from the POS site. The processing of the authorization request message may nonetheless be implemented in real-time during the purchase transaction. A response is sent to the POS site of the merchant specifying any discounts, funds or other benefits to apply to the purchase transaction in real-time. Details regarding any transaction benefits are thus presented or otherwise available contemporaneously with the purchase transaction at the POS site. The consumer is able to obtain immediate feedback at the POS site despite the use of a remote processing system to determine the nature or amount of the program benefit.

A processing system operated by the manufacturer agent receives the authorization request message and determines if the consumer account is valid. A validation process may be implemented to determine, for instance, that the account has been issued, is active, and/or has not expired. Assuming that the account and other information is valid, the agent calculates or determines in act 30 a benefit to be extended to the consumer in connection with the purchase transaction. With some program types, the benefit is a discount to be applied to an amount due for the purchase transaction. The discount may be specified on a per product basis, or as an amount to be applied against the total price of the products of a manufacturer. Alternatively or additionally, if the account is a prepaid account, for instance, the manufacturer agent determines whether funds on the account may be applied to the purchase transaction.

The benefit determination or calculation may be made based on one or more factors (e.g., rules) of the program. For example, one program factor may specify a requisite minimum quantity of the product(s) being purchased. Alternatively or additionally, a program factor may specify a minimum price of a product being purchased and/or a requisite minimum total value of the manufacturer's specified products in the purchase transaction. Other factors may be based on past transactions involving the consumer. To that and other ends, the manufacturer and/or its agent or representative may create and maintain a consumer transaction history database, in which data indicative of past purchase transactions and/or benefits is stored, as described below. Still other exemplary factors include the date of the present transaction relative to specific valid time period, usage scenarios (e.g., single use, double use, etc.), etc. Some factors may impose a cap or other limitation on the benefits to be applied to a single transaction, such as a maximum transaction benefit. The nature and number of the factors may vary considerably from the examples provided. For example, program factors may include varying pieces of the consumer's account information (such as demographic information, transaction history, current history, etc.), dates of the offers, quantities being purchased, number of discounts per product per consumer and dollar amounts. Any combination of these and other factors may be used.

Once the benefit is determined, the manufacturer agent returns an authorization response message in act 32 to the merchant, the message specifying the discount amount or funds to be applied to the purchase transaction. Next, in act 34, the merchant calculates the amount remaining due after application of the discount or funds. The consumer then pays any remaining amount due in the purchase transaction in act 36. Implementation of the program may also include settlement of the transaction between the merchant, manufacturer, consumer and any other parties involved. As described below, such settlement may occur in real-time with the purchase transaction (e.g., contemporaneously with the calculation/determination of the discount, funds, other benefit or combination thereof). Alternatively or additionally, settlement processing may be implemented in batch form.

The above-described discount and funds-based program benefits may be provided separately from a non-manufacturer preference payment authorization. For instance, the consumer may present another instrument (e.g., a debit or credit card) to pay the balance in act 36. Alternatively, the instrument presented by the consumer may be a manufacturer preference payment card. In one embodiment, the manufacturer preference payment card is configured only for purchasing the manufacturer's products. In other embodiments, the manufacturer preference payment card may be used for all of the merchandise being purchased by the consumer.

Further details regarding the filtering process implemented by the merchant in act 28, and the validation and calculation processes implemented by the manufacturer agent in act 30 are provided below. The filtering, message transmission, validation, calculation, and message receipt processes are implemented during the purchase transaction so that the benefits can be applied at the POS site in real-time.

FIG. 1 also depicts how the processing acts implemented by the disclosed methods are distributed between the merchant system(s) and the manufacturer agent system(s). The transmission of purchase transaction data to the manufacturer agent processing system supports the creation of a purchase transaction history for each consumer. Data in the purchase transaction history may be used to determine whether program benefits are applicable in future transactions (e.g., past purchase amounts as a program factor) and/or for analysis by the manufacturer for other purposes (e.g., data mining). In an alternative embodiment, the manufacturer agent processing system may be configured to implement one or more product filtering acts either in conjunction with or as an alternative to those occurring at the merchant.

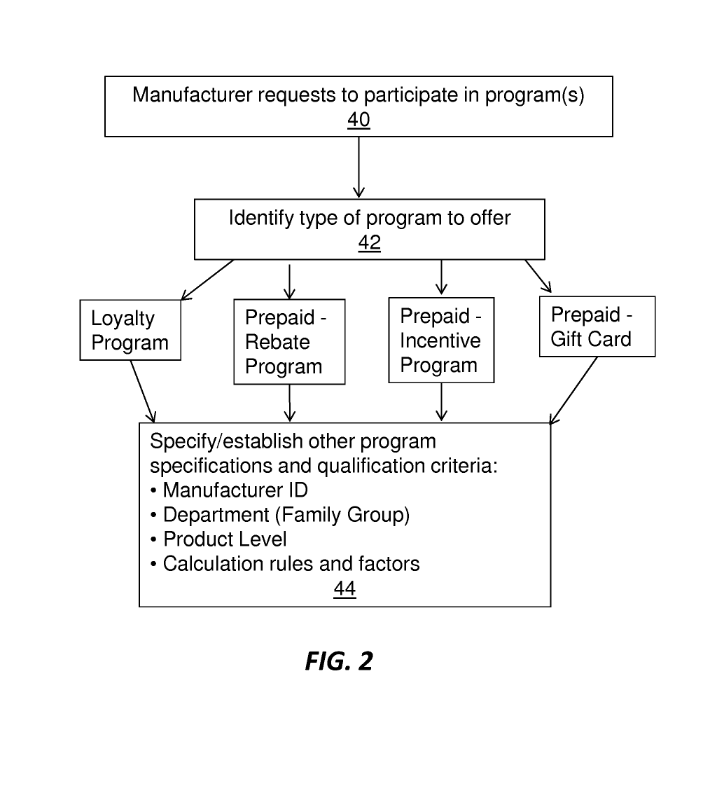

FIG. 2 depicts a number of steps taken by the manufacturer to establish or configure the manufacturer preference program. In act 40, the manufacturer requests to participate in one or more programs. The manufacturer identifies the type of program to be offered in act 42. Examples of program types include loyalty programs, prepaid rebate programs, prepaid incentive programs, and prepaid gift card programs. Additional, fewer, or alternative program types may be offered. For example, the loyalty program may also be offered in addition or alternative to the above-identified programs. In some cases, the manufacturer preference program may include or integrate multiple program types. With respect to each program type, the manufacturer specifies in act 44 one or more specifications of the program. For example, a number of factors may be specified to establish rules for obtaining the benefits of the program. Details of the program, such as the manufacturer identification code, may also be established in act 44. The manufacturer may also specify department product level details, such as a family group of products or specific products to which the program applies.

The manufacturer may implement the above-described processes of establishing a preference program through a third party, which may act as an agent or representative of the manufacturer during implementation and duration of the program. The nature of the third party may vary. For example, the third party may be any type of institution, such as financial, or company, such as a processor.

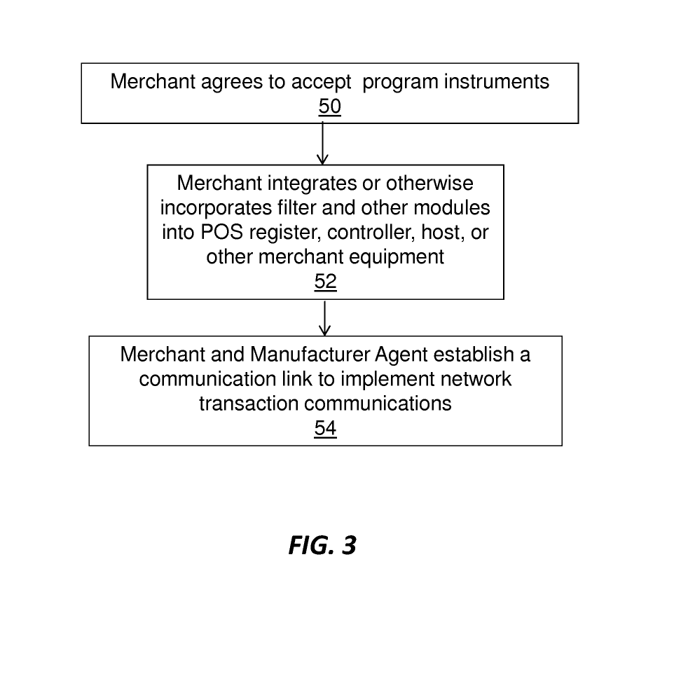

FIG. 3 depicts the configuration of the manufacturer preference program at the retailer or other merchant. In act 50, the merchant agrees to accept program cards or other instruments from consumers. To that end, the merchant integrates or otherwise incorporates in act 52 instrument scanner functionality into POS equipment, such as a POS register. Additionally, filtering, authorization request, authorization response, funds application and funds settlement functionality is integrated into a controller, host, or other processing device at the merchant. In one embodiment, the additional functionality is configured as one or more modules having a set(s) of instructions for filtering the products generally based on the manufacturer, generating the authorization request message, receiving the authorization response message, applying discounts or funds if any, and settling amounts, on a computer or other processing device. The merchant and the manufacturer agent (or other processor) may establish in act 54 a communication link to implement any messaging involved in the purchase transaction and implementation of the manufacturer preference program. The communication link may include or involve a network maintained or utilized by the manufacturer agent or processor to support the manufacturer preference program.

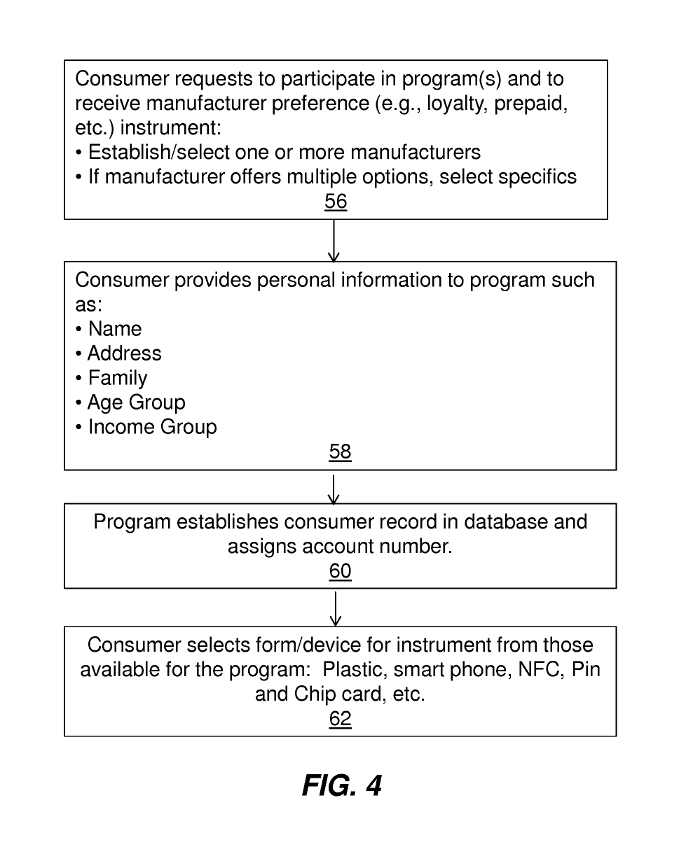

FIG. 4 depicts an exemplary process by which a consumer elects to participate in a manufacturer preference program. In act 56, a consumer request to participate is received. The request may be in the form of an application for an instrument such as a card. In some cases, the request form may be completed and/or received via an Internet website. The website may be hosted by a manufacturer, manufacturer agent or a processor for the manufacturer preference program, or another entity associated with the program.

In the process of completing the request form, the consumer selects one or more manufacturers. In these and other ways, the consumer may create a custom or unique card or instrument involving any number of manufacturers and, thus, any number of manufacturer preference programs. In some cases, the number of manufacturers or programs per card may be limited by a program specification, a manufacturer, a manufacturer agent, a processor, card issuer, or other aspect or entity of the program. With respect to each selected manufacturer, the request form may provide an opportunity for the consumer to select one or more program options. For example, the consumer may request a particular type of program (e.g., loyalty, prepaid, etc.). Further information regarding the consumer is received in act 58. In this example, the consumer provides name, address, family, age, income, and other information. Additional, less, or alternative information may be provided. A consumer record may be established in a database in act 60, and an account number for the consumer may be assigned. The consumer may also be provided an opportunity to select in act 62 the form of the instrument to be used by the consumer. In some examples, the form of the instrument is a card. Examples of other forms include electronic devices, such as a smart phone or other mobile or handheld device. In these and other examples, the device may be configured to implement near field communications (NFC). Alternatively or additionally, the instrument may include a pin and chip device.

The acts described above (and elsewhere herein) may be implemented in an order other than the depicted order. Additional, fewer, or alternative acts may be implemented in connection with this and any other figure hereof.

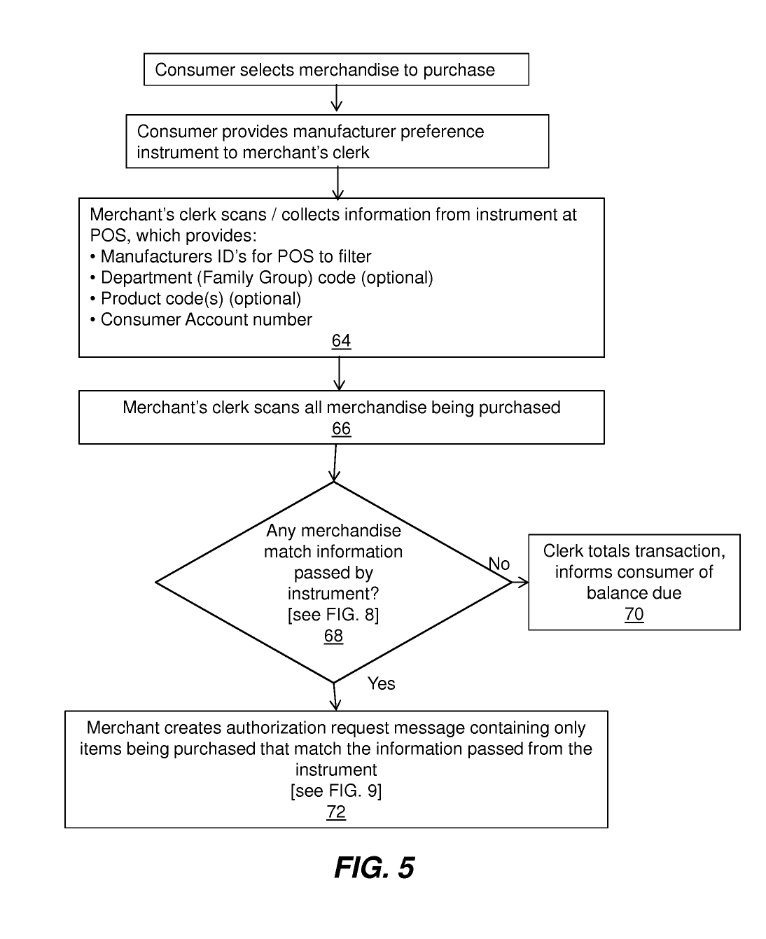

FIG. 5 depicts an exemplary implementation of a manufacturer preference program. The process may begin after the consumer selects merchandise for purchase and provides the manufacturer preference instrument (e.g., card) at a POS site of a merchant. Information regarding the consumer and the program is received in act 64 at the POS site, for instance, by a clerk operating a data collection device or system, such as a bar code scanner and/or magnetic stripe reader. For example, a bar code of a manufacturer preference card is scanned or read to obtain a consumer account code (e.g., a card number), one or more manufacturer identification codes (e.g., a manufacturer code), one or more product identification codes, and/or one or more other manufacturer related limitations on the program that may be used to filter the products to be purchased. Department or family group codes may also be provided. At or around that time, the consumer may place all merchandise being purchased on a platform to be scanned by the POS data collection device or system in act 66. The manner in which the consumer provides the merchandise may vary. For example, the POS site may include a virtual shopping cart.

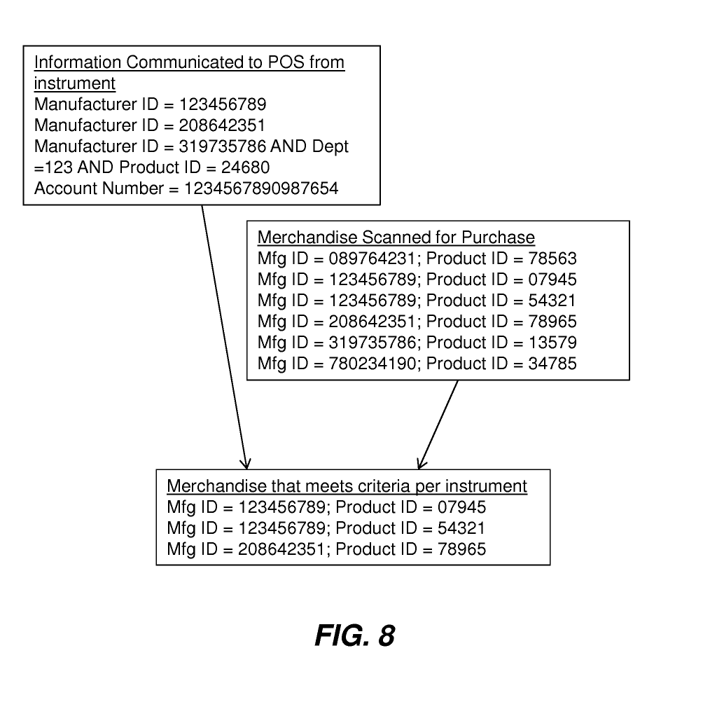

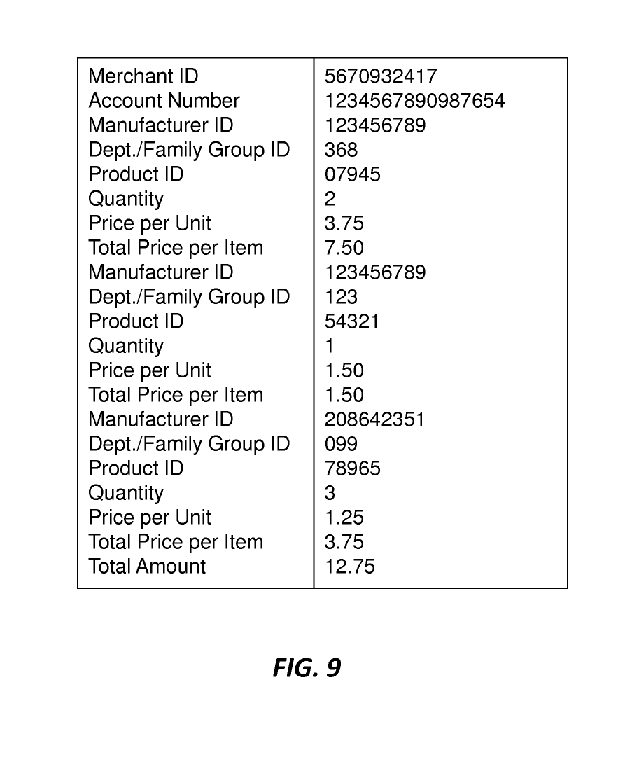

Once the information regarding the merchandise to be purchased is available, a filter operation is implemented in act 68 to determine whether any merchandise matches the information provided by the instrument. For example, the UPC codes of the merchandise to be purchased may be compared to the manufacturer identification code to determine whether any products of the manufacturer(s) are being purchased. Further details regarding an exemplary filter operation are provided in connection with FIG. 8. If no such products are being purchased, the clerk totals the purchase transaction in act 70, and informs consumer the balance due. No further acts relating to the manufacturer preference program are implemented. On the other hand, if one or more products of the manufacturer(s) are being purchased, then control passes to act 72 in which the merchant system creates an authorization request message to determine the benefit to be applied to the purchase transaction. The authorization request message may identify the merchant, consumer account code, the manufacturer identification code(s), and the product(s) of the manufacturer(s). Further details regarding an exemplary authorization request message are provided in connection with FIG. 9. In some embodiments, additional information may also be included in the authorization request message, including, for example, other product information (e.g., price and/or quantity data).

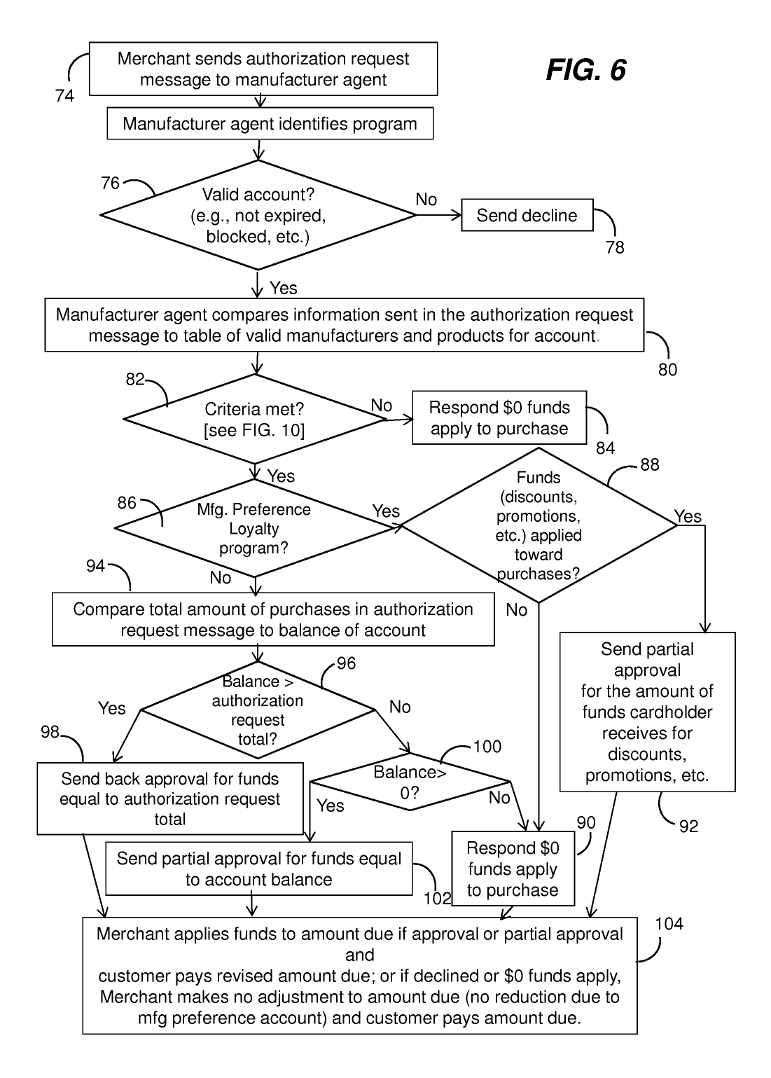

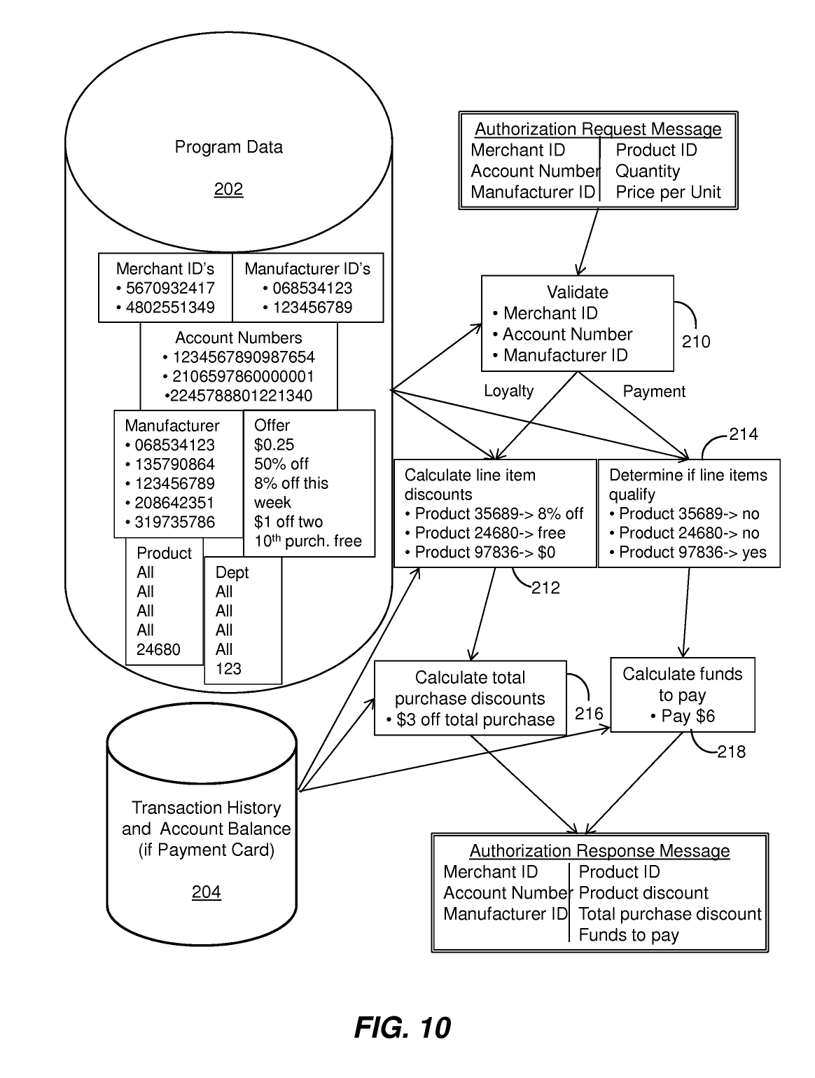

Further acts in the implementation of the manufacturer preference program are shown in FIG. 6. In act 74, the merchant sends the authorization request message to an agent of the manufacturer (processor) via a transaction network. The manufacturer agent (processor) may determine the nature of the consumer account identified in the authorization request message to determine one or more characteristics of the transaction benefit and may initially implement a validation process to determine if the account associated with the card or other instrument presented by the consumer is valid (e.g., not expired, blocked, etc.). If the account is determined to be not valid, then, in act 78, a decline authorization message is returned to the merchant and implementation of the manufacturer preference program ends. If the card is valid, the manufacturer agent (processor) compares the information provided in the authorization request message to a table, database, or other data store, and/or performs calculations or analysis in act 80 to determine in decision block 82 whether the merchandise purchased meets one or more criteria of the manufacturer preference program to possibly qualify for a purchase transaction benefit. Such criteria may be specific to the consumer account or the instrument presented by the consumer or to a particular manufacturer preference program or a combination thereof. The comparison or other analysis implemented in acts 80 and 82 may vary considerably based on the number and type of factors established for the manufacturer preference program. In one example, the analysis includes comparing the products of the manufacturer(s) to a table or list or other identification of products eligible for benefits under the program. An example of the application of program factors and criteria for transaction benefits is depicted in FIG. 10. If one or more of the factors of the program are not met, then a message indicating $0 funds to apply to the amount owed is sent in act 84.

If the criteria of the program, however, are met, then control passes to act 86, in which the manufacturer agent (processor) reviews the nature of the account. In the example shown, control passes to a decision block 88 if the consumer has elected to participate in a loyalty account program, at which point the manufacturer agent (processor) may determine whether any funds (e.g., discounts, promotions, etc.) may be applied toward the current purchase transaction of the qualified items. If no funds or discounts are determined to be applicable, then a message indicating $0 funds to be applied to the amount owed is sent in act 90. If funds are to be applied toward the qualified items of the current purchase transaction under a loyalty program, then control passes to act 92 in which a message indicating partial approval for an amount of funds to be received as a discount, promotion, etc., is sent to the merchant.

In the example of FIG. 6, non-loyalty card circumstances involve a payment (such as prepaid) card or other instrument. In these cases, the manufacturer agent (processor) compares in act 94 the total transaction amount of the filtered manufacturer products that meet the program criteria to the balance presently on the account. The decision block 96 determines whether the balance exceeds an authorization request amount for the products that meet the criteria. If so, control passes to act 98, in which an authorization response message is sent approving an amount for the products that meet the criteria of the purchase transaction. If not, control passes to a decision block 100, in which the manufacturer agent (processor) determines whether the balance on the card is greater than zero. If so, then an authorization response message is sent in act 102 to the merchant indicating partial approval equal to the card balance. If not, then control passes to act 90 for transmission of a message indicating $0 funds to be applied.

The implementation of the manufacturer preference program continues in act 104 at the POS site, where the merchant applies any discounts or funds to the amount due in the purchase transaction. The application of the discounts or funds may reflect the approval or partial approval described above. The consumer may then pay the remaining purchase transaction total reflecting the discount or other applied funds. In this way, based on the response message sent from the manufacturer agent (processor), any discounts may be applied to the merchandise purchased (or a subset thereof), and/or funds on the card may be used for the purchase of specified items based on the manufacturer and products, if applicable.

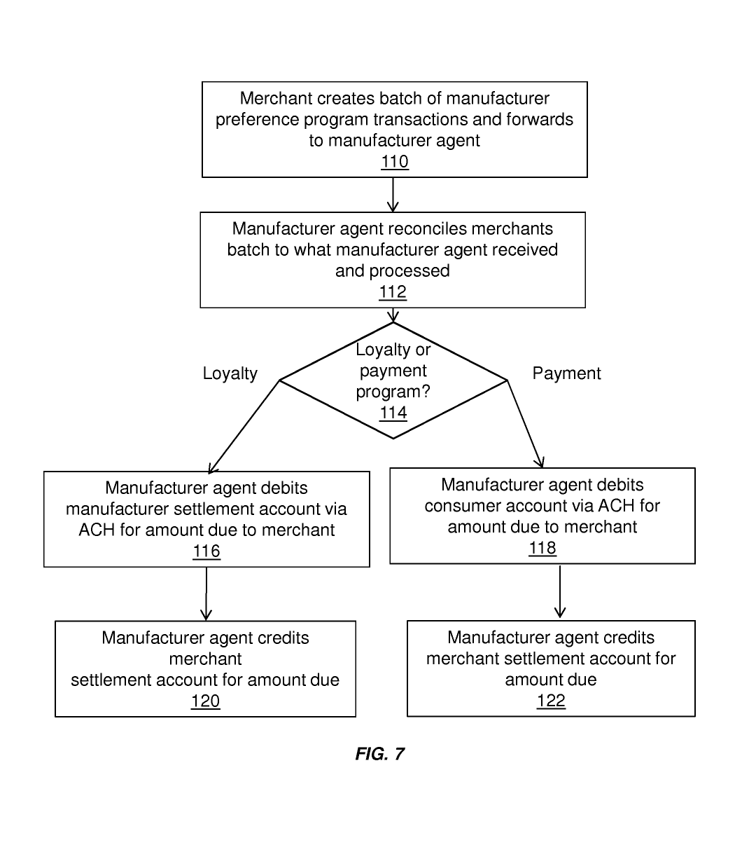

Turning to FIG. 7, implementation of the manufacturer preference program may also include settlement procedures for funds applied to the purchase transaction. The procedures may address settlement between the merchant, the manufacturer, and/or the consumer. For example, settlement may include paying the merchant for any discounts or funds applied to the purchase and taking the funds from the manufacturer or, in the case of a payment instrument, the account associated with the payment instrument. In the example shown, a merchant initiates a settlement process by creating in act 110 a batch of manufacturer preference program transactions and forwarding the batch to the manufacturer agent processing system or other processor or representative of the manufacturer or other third-party administering the program. The merchant may wait until a predetermined number of transactions have occurred to send the batch and/or follow a predetermined schedule of regular batch transmissions. For example, the merchant may identify the amount of discounts or funds applied that occurred by accepting the manufacturer(s) preference instruments for the current business day, and transmit the information to the manufacturer agent (e.g., processor) at the end of the day. Alternatively or additionally, the merchant initiates the settlement process upon the completion of a purchase transaction involving the program. The manufacturer agent (e.g. processor) may then analyze the data in the transmission from the merchant to reconcile in act 112 the data with the purchase transaction history data maintained by the manufacturer agent (e.g., processor). A decision block 114 may then be implemented to address different types of program instruments calling for different settlement transactions. In this example, two options are addressed. Additional, fewer, or alternative options may be addressed. If the underlying purchase transaction involved a loyalty instrument benefit, then control passes to act 116, in which the manufacturer agent (e.g., processor) debits a manufacturer settlement account in an amount corresponding to the amount due to the merchant. If the underlying purchase transaction(s) instead involved a payment instrument, then control passes to act 118, in which a settlement account of the payment instrument is debited in an amount corresponding to the amount due to the merchant. In prepaid card scenarios, for example, the account associated with each payment instrument may be debited the respective amount that was accepted from the manufacturer preference instrument. Corresponding credits to the merchant settlement accounts are also made in acts 120 and 122 as shown. In each case, the debit or credit may occur via an Automated Clearing House (ACH) or other financial transfer or transaction. Such payments and other aspects of the settlement procedures may be implemented in real-time, reducing or eliminating any delays between the purchase transaction and any settlement transactions.

While the nature of the settlement procedures may vary from the example shown, implementation of the disclosed methods, systems, and computer-readable media allow the manufacturer or account associated with the payment instrument to reimburse the merchant directly or indirectly in an automated manner. With the transaction history generated via implementation of the program, the reimbursements are linked to the discounts or funds applied for specific products purchased. The transaction history also allows the manufacturer agent (e.g., processor) to confirm the amount of discounts or funds applied that occurred.

In some embodiments, settlement requests are submitted to a network operator for payment. The network operator sends a settlement request to the manufacturer agent (e.g., processor) or issuer (including the issuer agent such as a processor) of the manufacturer preference card program. In one example, an issuing processor (as the issuer agent) then matches the financial information to the held authorization transactions. The matching may be based on a variety of matching criteria, such as time/date of the purchase transaction, authorized amount, name of merchant, network trace numbers or other identifying information. The network operator may then direct the settlement of funds between the issuer's bank and the merchant's bank.

Alternatively, if a direct link is used to connect the merchant with the manufacturer agent, e.g., the manufacturer preference payment instrument (e.g., prepaid card, etc.) processor, the merchant submits the total amount that was accepted from the manufacturer's payment card to the processor for payment. The processor matches the financial information provided by the merchant to the held authorization transactions. The matching may be based on a variety of matching criteria, such as time/date of the purchase transaction, authorized amount, name of merchant, network trace numbers or other identifying information. The processor may then direct the settlement of funds between the manufacturer's or issuer's bank and the merchant's bank as it normally would.

FIG. 8 depicts an exemplary filtering procedure implemented at the POS site via a merchant device or system. The merchant device or system is configured to receive the information stored on the card or other instrument presented by the consumer. In this example, a card provides the depicted data indicative of three manufacturer identification codes, the data for one of which (manufacturer code 319735786) is coupled with data indicative of a department group code (123) and a product code (24680), and a consumer account code or card number. The merchant device or system is also configured to receive data indicative of the merchandise to be purchased. The data may include a manufacturer code and a product code for each such product. These codes need not be formatted in the same manner as the codes provided by the instrument. A translation or transformation may be implemented to convert the codes. In this example, six products have been selected for purchase. The filtering process then identifies those of the six products that meet the filter data specified via the instrument. Thus, in some cases, the filter process passes those products associated with a manufacturer identified on the instrument, while in other cases the filter process also looks to the department group, product, or other code specified by the filter criteria. Three products meet the criteria in this example.

FIG. 9 depicts an exemplary authorization request message generated for the three products. The message may include a number of fields in addition to those identifying the manufacturer and product codes of the filtered products. In this example, such additional data is indicative of a merchant identification code, department/family group identification code, the consumer account number, quantity to be purchased, price per unit, total price per item, and total purchase amount of the manufacturer(s) products passed in the authorization request. Additional, fewer, or alternative fields may be provided. The fields and data may be arranged in accordance with any desired data communication protocol.

An example of the processing of an authorization request message and of program data used by the manufacturer agent (e.g., processor) in the processing is depicted in Figure 10. In this example three fields from the authorization request message—the merchant code, the consumer account number and the manufacturer code—are validated against the program data 202 in act 210. Additional program data is then accessed to determine the program type and related manufacturer-based purchase transaction benefit data for the products involved in the purchase transaction. Act 212 then calculates available line item discounts and act 214 determines if line items qualify for available funds from a prepaid card such as a gift card. In this example product 24680 is determined to be free and product 97836 is covered by the prepaid card. The processing continues in act 216 to calculate the amount the manufacturer will pay as applied discounts to the purchase transaction and in act 218 to calculate the amount of funds to apply to the purchase transaction. The processing may access the purchase transaction history and account balance data 204 as part of the determination of product discounts and funds to pay. In this example the consumer receives $3 in manufacturer purchase transaction benefits and the prepaid card pays $6 towards the purchase of product 97836. An authorization response message is then created using the merchant code, the consumer account number, the manufacturer code and the results from the above calculations and the processing concludes as the response message is sent to the merchant.

The example program data in FIG. 10 includes merchant identification codes, manufacturer identification codes, consumer account data and data specifying the factors and criteria to use in determining the manufacturer-based purchase transaction benefits. A database or other data store identifies a number of consumer accounts by respective card numbers. Each consumer account may be stored as a record in a table of the database. Alternative database formats may be used and any number of related attributes may be stored as part of the account information. Each consumer account has one or more manufacturers identified via respective manufacturer identification codes. The manufacturer identification codes may be accessed to confirm the information provided via the authorization request message. Another table of the database may be used to specify data for a number of database fields associated with each manufacturer and the program benefits available for various products. In this example, the database identifies the departments or family groups and products for which specific program benefits are available. In some cases, a code is stored in such fields to indicate that all departments or products are part of the program. For each such manufacturer, department/family group, and/or product, data indicative of the program offer or other benefit is specified. For example, purchases of all products from the manufacturer identified via manufacturer code 068534123 are eligible for a discount of $0.25 upon the presentation of a qualifying instrument. The example of FIG. 10 depicts a few of the wide variety of program benefits that may be offered by manufacturers.

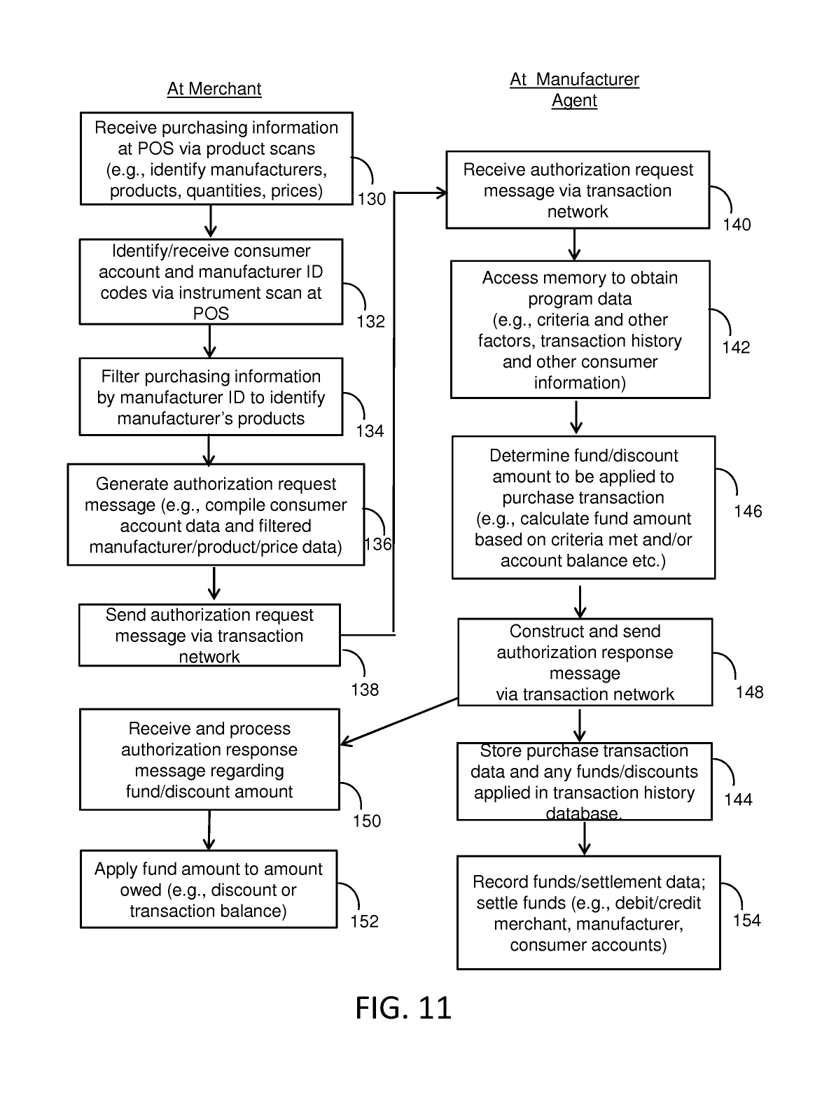

FIG. 11 depicts one or more methods or processes that may be implemented to facilitate a purchase transaction between a consumer and a merchant for a plurality of products, one or more of which are associated with one or more manufacturers for which a preference program has been established. The methods may be implemented by one or more computers or other processing devices. Such computer(s) or processing device(s) may be configured in accordance with computer code of one or more sets of instructions stored on a non-transitory computer-readable medium and executable by the processing device to implement the depicted methods or processes. In this example, the methods and/or instructions sets are implemented by systems or devices at either a merchant or a manufacturer agent (e.g., processor). The methods may begin with reception of purchasing information in act 130 such as products, quantities and prices at a POS site via a series of product scans during the purchase transaction. A consumer account of the consumer and a manufacturer identification code for each manufacturer are received or identified in act 132. The codes may be identified via a card or other instrument presented by the consumer to the merchant during the purchase transaction. In one example, the instrument is a card. Other types of instruments may nonetheless be associated or identify a preference with one or more manufacturers. The instrument may be scanned via the same device or equipment at the POS site configured to collect the purchase information, or a different device. The information provided by the instrument may be captured via other techniques. The instrument may include one or more storage devices or components in which data indicative of a plurality of manufacturer identification codes, a consumer account number and other information is stored. Any now or hereafter storage device, component, or technique may be used.

The purchase transaction product information is filtered in act 134 by a merchant device at the POS site (e.g., a register or other processing device) or other merchant site (e.g., a computer, controller, host device or other system). The merchant device may be configured to implement a filtering scheme or process directed to identifying those products of the plurality of products from the manufacturers identified via the instrument. The filtering process is based on the manufacturer identification code(s). In one example, the filtering process compares the manufacturer identification code(s) with the manufacturer information collected via the product scans. In act 136, the merchant device or system then generates an authorization request message that includes data indicative of the consumer account code, the manufacturer identification code(s), and a product identification code for each filtered product to be purchased. In one embodiment, the authorization request message further includes quantity and pricing information regarding one or more of the products of the purchase transaction (e.g., those products identified via the filtering process). The generation of the message may include a data compilation process to arrange the consumer account code and the filtered manufacturer and product codes, as well as price, quantity and other data desired by the manufacturer for benefit processing or analysis and/or storage in a transaction history database. The authorization request message is then sent via a transaction network in act 138 to a manufacturer agent or program benefits processor during the purchase transaction.

Upon reception of the authorization request message in act 140, a number of processing acts are then implemented by the manufacturer agent or program benefits processor, which may include one or more devices or systems located remotely from the POS site. The manufacturer agent or issuer agent (e.g., processor) may access in act 142 one or more memories or other data stores or data storage devices in which program data is stored. The program data specifies one or more program rules and factors for each manufacturer. For example, each program may include a rule specifying a criterion for qualifying for a transaction benefit. The program data may also include transaction history data, which may be stored in a separate database. One or more factors or rules may involve analysis of the transaction history data to determine whether the consumer and current purchase transaction qualify for a program benefit. For example, a rule may specify that the consumer's purchases in the last month (or other time period) have exceeded a cost or quantity threshold, by themselves or in combination with the current purchase transaction. In these and other examples, one or more of the factors may be based on the pricing information provided via the authorization request message.

With the program rules, criteria, transaction history and other information for the manufacturer(s) and consumer in hand, the manufacturer agent or issuer agent (e.g., processor) of the program may then determine in act 146 a fund amount or program benefit to be applied to the present purchase transaction to the qualified items. The determination may be based on the consumer account (or other identification) code, the manufacturer identification code(s), and the program factor(s) and rule(s). The determination may also be based on product quantity or pricing information for the present purchase transaction, or any other data provided by the authorization request message or accessed via the act 142 (or any combination thereof). The determination may thus include analysis of the past transaction data stored in the transaction history database regarding any number of previous purchase transactions involving the consumer. The analysis and/or other aspects of the determination may thus include calculations involving the price, quantity, timing, and other characteristics of the data. The calculations may also involve or include the processing of data for a plurality of factors, in which data for the factors is integrated or processed to any desired extent. For example, the fund amount to be applied to the present purchase transaction may be an aggregate discount calculated from a number of individual discounts or other benefits. Alternatively or additionally, the determination of the funds to apply for a payment instrument includes the balance of the account associated with the payment instrument.

The manufacturer agent or program benefits processor may then construct and send in act 148 an authorization response message to the merchant regarding application of the determined fund or discount amount to the purchase transaction. The authorization response message may thus include data indicative of the determined fund or discount amount. The authorization response message may be transmitted via the transaction network over which the authorization request message is sent. The authorization response message is sent during the purchase transaction. The determined fund amount may thus be applied to the purchase transaction in real-time, rather than subsequent to the purchase transaction. For example, when the instrument is a loyalty instrument, the authorization response message may be configured to direct the merchant to apply the fund amount as a discount in the purchase transaction. The merchant device or system thus receives the authorization response message in act 150 during the purchase transaction so that the fund amount may be applied in act 152 at the POS site as a discount to the purchase transaction. Additionally, the manufacturer agent or issuer agent (e.g. processor) of the program may store in act 144 data indicative of the present purchase transaction in the transaction history database or other memory or data store.

The exemplary method of FIG. 11 may include a number of further procedures directed to settlement of the purchase transaction. Implementation of the procedure(s) occurs in act 154 and may be initiated, controlled, or executed by the manufacturer agent or issuer agent (e.g., processor). The nature of the procedures may depend upon one or more characteristics of the purchase transaction, the instrument presented by the consumer, and/or the program funds applied during the purchase transaction. For example, a manufacturer settlement account associated with the manufacturer may be debited in an amount that corresponds with the fund amount applied to the purchase transaction. A merchant settlement account associated with the merchant may then be credited in an amount that corresponds with the fund amount applied to the purchase transaction. When the type of program is a payment program, an account which holds the funds associated with the payment instrument of the consumer may be debited in an amount that reflects the fund amount applied to the purchase transaction. These and other settlement procedures may include any number of financial transactions, account record updates, and other acts or procedures. Each such act or procedure may be implemented in real-time commensurate with the purchase transaction and/or in batch form.

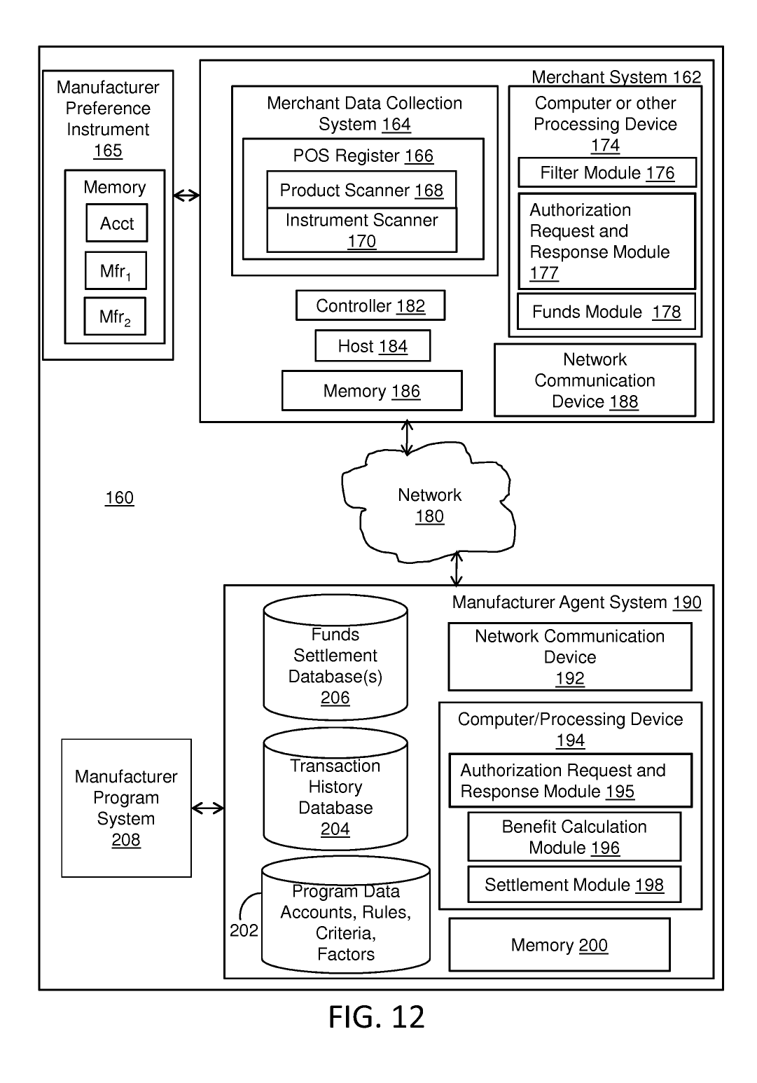

FIG. 12 depicts an exemplary system 160 for facilitating a purchase transaction between a consumer and a merchant for a plurality of products, at least one of which is associated with a manufacturer that has established a program for purchase transaction benefits (including manufacturer preference payment programs). The system 160 includes a merchant system 162 associated with the merchant, the merchant system 162 including one or more devices, subsystems, or other systems at a POS site or other locations. In this example, the merchant system 162 includes a merchant data collection system 164 configured to obtain product information regarding the plurality of products during the product transaction. The merchant data collection system 164 is further configured to obtain information from the consumer regarding the manufacturer preference program via an instrument 165 presented by the consumer to the merchant during the purchase transaction. In this example, the merchant data collection system 164 includes a POS register or terminal 166 having one or more scanners or other data input devices, such as a product scanner 168 (e.g., a platform scan device) and an instrument scanner 170 (e.g., a card swipe device). Any present or hereafter developed scan or data capture technology may be used.

The instrument scanner 170 captures and/or processes data related to the manufacturer preference program, such as a consumer account code for the consumer, a manufacturer identification code for the manufacturer(s), and any other data stored on the instrument presented by the consumer. In the example shown in FIG. 12, the instrument 165 includes a memory or other data storage component or device (e.g., a bar code, computer chip) in which the consumer account code (Acct) is stored to identify the consumer and a pair of manufacturer identification codes (Mfr₁, Mfr₂) are stored to identify two manufacturers for which program funds may be available for the consumer. The construction and other characteristics of the memory and other components of the instrument 165 may vary. The construction, configuration, and other characteristics of the instrument scanner 170 may thus vary in accordance with the characteristics of the instrument 165 and the instrument memory.

The information provided via the bar code or other storage component of the instrument presented by the consumer may vary. For example, the information may include a manufacturer identification code(s), a manufacturer identification code with a department/family group code(s), or a manufacturer identification code with both department/family group codes and any number of product codes. The information may also include a consumer account number. Additional or alternative information may be provided via the instrument to, for instance, facilitate the filtering implemented at the POS site.

The arrangement and configuration of the data presented via the instrument may vary. For example a loyalty card may use a GS1 DataBar barcode which contains a GS1 Application Identifier with an accompanying GS1 ID Key for a Global Service Relation Number, representing a manufacturer identification code and consumer account code. A further loyalty example may have a bar code with the data identified above plus another GS1 Application Identifier with an accompanying GS1 ID Key for a Global Trade Item Number representing a manufacturer identification code and a product code.

The POS register 166 may also include a control module including one or more sets of instructions stored on a computer-readable medium in the POS register 166 or other device or component of the merchant data collection system 164. The instruction set(s) may include computer code and other data configured to capture the aforementioned data from the instrument.

The merchant system 162 also includes a computer or other processing device 174 to process the data captured by the data collection system 164. The computer 174 may include a number of modules to process the captured data and/or implement one or more aspects of the program, such as the application of a manufacturer preference program to the purchase transaction. In this example, the computer 174 includes a filter module 176, an authorization request and response module 177, and a fund application module 178. Each module 176, 177, and 178 may be incorporated into the computer 174 as part of a pre-existing processing device handling various computing tasks of the merchant, or as part of a standalone computer. The filter module 176 may thus be configured to retrieve or receive product information from the product scanner 168 and manufacturer information from the instrument scanner and identify the respective manufacturer product of the plurality of products by filtering the product information based on the manufacturer identification code(s). The authorization request and response module 177 may be configured to generate, for transmission via a transaction network 180, an authorization request message. The authorization request and response module 177 may retrieve or receive the consumer account code and the manufacturer identification code(s) from the instrument scanner 170 or POS register 166, and product information for the filtered products from the filter module 176. The authorization request and response module 177 may be configured to receive an authorization response message back from the transaction network 180 and deliver the response to the funds module 178. The funds module 178 then applies any funds or discounts to the purchase transaction. The funds module 178 may be an existing merchant module or an interface module to the merchant's existing funds allocation module. One or more components of the computer 174 may be integrated with various merchant computing devices, such as controllers 182 and/or hosts 184.

The merchant may have multiple controllers 182 at each merchant location. For example, each department within a store may have a respective one of the controllers 182, each of which is in communication with the POS registers 166 within the department. Each store may, in turn, have one host 184. The filter module 176 and/or other modules or components of the disclosed systems may be integrated into the controllers 182 and/or the hosts 184, such that the filtering and other processing need not be addressed by a computing device at each POS site individually. The arrangement of the modules and other components of the disclosed systems may vary, as the filtering and other functionality may be distributed or centralized to any desired extent.

The computer 174 may include one or more memories 186 for storing instruction sets, data captured at the POS sites, and any other data involved in the purchase transactions. The memory(ies) 186 may be any data store or other data storage device or component. The memory(ies) 186 may be integrated with the computer 174 to any desired extent. Alternatively, the memory(ies) 186 may be in communication with the computer 174 via any communication technique, protocol, etc. The construction, configuration, and other characteristics of the memory(ies) 186 may vary, and may include any now or hereafter developed storage technology.

The merchant system 162 may include a network communication device 188 to support the reception and transmission of messages or other communications for the merchant system 162 via the transaction network 180. The network communication device 188 may be integrated with the computer 174, the controller 182, and/or the host 184 to any desired extent.

The system 160 includes a manufacturer agent system 190 in communication with the components of the merchant system 162 via the transaction network 180. To that end, the manufacturer agent system 190 may include a network communication device 192 to receive the authorization request message from the computer 174. The manufacturer agent system 190 may be implemented by the manufacturer or a representative or agent thereof, such as a processor. The manufacturer agent system 190 includes one or more computers or processing devices 194 to process the authorization request messages to determine a fund amount to be applied to the purchase transaction. The determination may include a number of calculations, and/or may be based on the consumer account code, the manufacturer identification code, the program rules, criteria and factors, and/or other data (e.g., price data, the account balance associated with the payment instrument, transaction history), as described above. In this example, the computer 194 includes an authorization request and response module 195, a benefit calculation module 196, and a settlement module 198. The authorization request and response module 195 receives the authorization request message from the computer 174 and manages the benefit determination and subsequent response to the computer 174. The benefit calculation module 196 determines the funds or discounts to be applied as described above. The authorization request and response module 195 may further be configured to generate and send an authorization response message during the purchase transaction to the merchant via the transaction network 180 regarding application of the determined fund amount in connection with the purchase transaction. The settlement module 198 may be configured to implement one or more of the settlement operations described above, which may be carried out via the transaction network 180.

The manufacturer agent system 190 may include one or more memories 200 for storing instruction sets and data involved in the fund amount determination. The memory(ies) 200 may be any data store or other data storage device or component. The memory(ies) 200 may be integrated with the computer 194 to any desired extent. Alternatively, the memory(ies) 200 may be in communication with the computer 194 via any communication technique, protocol, etc. The construction, configuration, and other characteristics of the memory(ies) 200 may vary, and may include any now or hereafter developed storage technology.

In this example, the manufacturer agent system 190 includes a number of additional memories dedicated to storing records and other data in support of the manufacturer preference program(s). Each such memory may be in communication with the computer 194 or integrated therewith (or the memory 200) to any desired extent. The memories may alternatively or additionally be integrated with one another. For example, the memories may be configured as separate databases managed by a common database management system. The system 190 includes a memory 202 in which manufacturer preference program data is stored, the manufacturer preference program data specifying one or more program rules, criteria and factors for each manufacturer, and may include consumer account information. Another memory 204 is configured to store data indicative of the purchase transaction, thereby creating a transaction history database of previous purchase transactions involving the consumer. The computer 194 may access the transaction history database to obtain past transaction data on which the fund amount determination is further based.

The manufacturer agent system 190 also includes one or more account or fund settlement databases 206 in which data indicative of one or more settlement account(s) is stored. The settlement accounts may be associated with the manufacturers, the merchants, and/or the consumers involved in the program. In this example, the settlement module 198 of the computer 194 may access the databases 206 to debit or credit the settlement accounts in an amount that corresponds with the fund amount applied in connection with the purchase transaction. For example, when the instrument presented by the consumer is a payment card, the settlement module 198 may access the account database 206 in which data indicative of a payment card account of the consumer is stored. The computer 194 may then be configured to debit the payment card account in an amount that reflects the fund amount applied in connection with the purchase transaction.

In some cases, the program data database 202, the transaction history database 204, the fund settlement database 206, and/or other components of the manufacturer agent system 190 may be accessible to the manufacturer. In this example, a manufacturer program system 208 may be in communication with the manufacturer agent system 190 to facilitate updates to the program specifications and factors or other configuration of the program or program related data. The manufacturer program system 208 may alternatively or additionally be in communication with the manufacturer agent system 190 to access the purchase transaction data in the transaction history database 204 for data mining and other analysis. Additionally or alternatively, the transaction history data may be provided to the manufacturer via batch files.

The above-described methods, systems, and computer-readable media may create or facilitate direct, one-to-one relationships between the consumer and manufacturer. The disclosed solution links directly to specific product sales and/or specific consumers, generating loyalty to the manufacturer. The disclosed solution also addresses how the vast majority of mass market consumer products are still sold through intermediaries such as grocery store chains, drug stores, superstores and other merchants.

The term “product” is used to include a variety of different goods or services, including, for instance, any commodity (whether tangible or intangible), article, or other good or service. The term “manufacturer” is used to include a variety of different product sources, and is not limited to entities involved in fabrication. The term “manufacturer” may refer to an entity involved in any stage of the production of a product or service.

The above-described methods, systems, and computer-readable media may provide advantages at POS locations because each POS location need not calculate the consumer discount or other transaction benefit or in the case of a payment instrument, the funds applied to the qualifying products. The amount of processing occurring at the POS location may decrease through application of the above-described methods, systems, and computer-readable media.

The systems and devices described above, including, for instance, the merchant data collection system, the merchant filter device, and the manufacturer agent or issuer agent system, may include central processing unit(s) (CPU), graphics processing unit(s) (GPU), or both. The processing units may be a component in a variety of systems. For example, the processing units may be part of a standard personal computer or a workstation or a server. The processing units may be one or more general processors, digital signal processors, application specific integrated circuits, field programmable gate arrays, servers, networks, digital circuits, analog circuits, combinations thereof, or other now known or later developed devices for analyzing and processing data. The processing units may implement a software program, such as code generated manually (i.e., programmed).

The disclosed systems and devices may include a memory. The memory may communicate via a bus. The memory may be a main memory, a static memory, or a dynamic memory, or any combination thereof. The memory may include any number of memories or data storage devices. The memory may include, but may not be limited to computer-readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory may include a cache or random access memory for the processor. Alternatively or additionally, the memory may be separate from the processor, such as a cache memory of a processor, the system memory, or other memory. The memory may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory may be operable to store instructions executable by the processing unit(s) of the respective system. The functions, acts or tasks illustrated in the figures or described herein may be performed by the programmed processing units executing the instructions stored in the memory. The functions, acts or tasks may be independent of the particular type of instruction set, storage media, processing unit or processing strategy and may be performed by software, hardware, integrated circuits, firm-ware, micro-code and the like, operating alone or in combination. Likewise, processing strategies may include multiprocessing, multitasking, multicore, parallel processing and the like.

The disclosed systems and devices may further include a display, such as a liquid crystal display (LCD), an organic light emitting diode (OLED), a flat panel display, a solid state display, a cathode ray tube (CRT), a projector, a printer or other now known or later developed display device for outputting determined information. The display may act as an interface for a user to see the functioning of the processing unit, or specifically as an interface with the software stored in the memory or in the drive unit.

Additionally, the disclosed systems and devices may include an input device configured to allow a user to interact with any of the components of the system. The input device may be a number pad, a keyboard, or a cursor control device, such as a mouse, or a joystick, touch screen display, remote control or any other device operative to interact with the system.

The disclosed systems and devices may also include a disk or optical drive unit. The disk drive unit may include a computer-readable medium in which one or more sets of instructions, e.g. software, can be embedded. Further, the instructions may perform one or more of the methods or logic as described herein. The instructions may reside completely, or at least partially, within the memory and/or within the processing unit during execution by the computer system. The memory and the processing unit also may include computer-readable media as discussed above.

The network(s) or other communication connections described above may include wired networks, wireless networks, or combinations thereof. The wireless network may be a cellular telephone network, an 802.11, 802.16, 802.20, or WiMax network. Further, the networks may be a public network, such as the Internet, a private network, such as an intranet, a wide-area-network or a local-area-network, or combinations thereof, and may utilize a variety of networking protocols now available or later developed including, but not limited to TCP/IP based networking protocols.

The computer-readable medium may be a single medium, or the computer-readable medium may be a single medium or multiple media, such as a centralized or distributed database, and/or associated caches and servers that store one or more sets of instructions and/or data. The term “computer-readable medium” may also include any non-transitory medium or tangible medium that may be capable of storing, encoding or carrying a set of instructions for execution by a processing unit or that may cause a computer system to perform any one or more of the methods or operations disclosed herein.

The computer-readable medium may include a solid-state memory such as a memory card or other package that houses one or more non-volatile read-only memories. The computer-readable medium also may be a random access memory or other volatile re-writable memory. Additionally, the computer-readable medium may include a magneto-optical or optical medium, such as a disk or tapes or other storage device. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored in a non-transitory manner.

Alternatively or additionally, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively or additionally, virtual computer system processing may be constructed to implement one or more of the methods or functionality as described herein.

While the present invention has been described with reference to specific examples, which are intended to be illustrative only and not to be limiting of the invention, it will be apparent to those of ordinary skill in the art that changes, additions and/or deletions may be made to the disclosed embodiments without departing from the spirit and scope of the invention.

The foregoing description is given for clearness of understanding only, and no unnecessary limitations should be understood therefrom, as modifications within the scope of the invention may be apparent to those having ordinary skill in the art.

1. A method of facilitating a purchase transaction between a consumer and a merchant for a plurality of products, a respective product of which is associated with a manufacturer, the method comprising:
receiving, during the purchase transaction, from the merchant via a communication network, an authorization request message for the purchase transaction, wherein:
the authorization request message comprises a consumer account code for the consumer, a manufacturer identification code for the manufacturer, a product identification code for the respective product, and pricing data for the respective product,
the consumer account code and the manufacturer identification code are obtained by the merchant from the consumer via an instrument presented by the consumer to the merchant during the purchase transaction, and
the respective product is identified at the merchant by filtering the plurality of products based on the manufacturer identification code such that the authorization request message comprises a filtered list of the plurality of products;
accessing a memory in which program data is stored, the program data specifying a program factor for the manufacturer;
implementing, with a processing device, a procedure that determines a fund amount to be applied in connection with the purchase transaction based on the program data and data in the authorization request message; and
sending, during the purchase transaction, to the merchant via the communication network, an authorization response message regarding application of the determined fund amount.

2. The method of claim 1, wherein the program factor comprises a rule specifying a criterion for qualifying for a transaction benefit.

3. The method of claim 1, wherein the program factor comprises a rule specifying a calculation for quantifying a transaction benefit.

4. The method of claim 1, wherein the fund amount is further determined based on an available consumer account balance.

5. The method of claim 1, wherein the fund amount is further determined based on consumer demographic data.

6. The method of claim 1, further comprising storing data indicative of the purchase transaction in a transaction history database, and wherein implementing the procedure further comprises analyzing past transaction data stored in the transaction history database regarding a previous purchase transaction involving the consumer.

7. The method of claim 1, further comprising transferring funds by:
debiting a first settlement account associated with the manufacturer or a payment card in an amount that corresponds with the determined fund amount;
crediting a second settlement account associated with a merchant, a charity or an individual in an amount that corresponds with the determined fund amount; and
recording settlement transactions in a funds settlement database.

8. The method of claim 1, wherein the instrument is a loyalty card for one or more manufacturers.

9. The method of claim 1, wherein the instrument is a payment card configured for purchase only of products from the manufacturer.

10. A non-transitory computer-readable medium having stored therein instructions executable by a programmed processing device for facilitating a purchase transaction between a consumer and a merchant for a plurality of products, a respective product of which is associated with a manufacturer, the instructions comprising computer code to:
receive product information regarding the plurality of products during the purchase transaction;
receive a consumer account code for the consumer and a manufacturer identification code for the manufacturer via an instrument presented by the consumer to the merchant during the purchase transaction;
identify the respective product of the plurality of products by filtering the product information based on the manufacturer identification code to generate a filtered list of the plurality of products;
generate an authorization request message comprising the consumer account code, the manufacturer identification code, the filtered list of the plurality of products comprising a product identification code for the respective product, and pricing data for the respective product, the authorization;
send the authorization request message via a communication network to a system of a manufacturer agent during the purchase transaction;
receive, during the purchase transaction from the system of the manufacturer agent via the communication network, an authorization response message regarding a fund amount to be applied to the purchase transaction, the fund amount being determined based on a program factor for the manufacturer and further based on the consumer account code; and
apply the fund amount to the purchase transaction.

11. The non-transitory computer-readable medium of claim 10, wherein the instructions comprise further computer code to implement a settlement of funds to a merchant account.

12. The non-transitory computer-readable medium of claim 10, wherein the instructions comprise further computer code to receive a department code, a family code, or a product code via the instrument, and wherein the instructions to identify the respective product is further based on the department code, the family code, or the product code.

13. A non-transitory computer-readable medium having stored therein instructions executable by a programmed processing device for facilitating a purchase transaction between a consumer and a merchant for a plurality of products, a respective product of which is associated with a manufacturer, the instructions comprising computer code to:
receive, during the purchase transaction, from the merchant via a communication network, an authorization request message for the purchase transaction, wherein:
the authorization request message comprises a consumer account code for the consumer, a manufacturer identification code for the manufacturer, a product identification code for the respective product, and pricing data for the respective product,
the consumer account code and the manufacturer identification code are obtained by the merchant from the consumer via an instrument presented by the consumer to the merchant during the purchase transaction, and
the respective product is identified at the merchant by filtering the plurality of products based on the manufacturer identification code such that the authorization request message comprises a filtered list of the plurality of products;
access a memory in which program data is stored, the program data specifying a program factor for the manufacturer;
determine, with a processing device, a fund amount to be applied in connection with the purchase transaction based on the program data and data in the authorization request message; and
send, during the purchase transaction, to the merchant via the communication network, an authorization response message regarding application of the determined fund amount in connection with the purchase transaction.

14. The non-transitory computer-readable medium of claim 13, wherein the program factor comprises a rule specifying a criterion for qualifying for a transaction benefit.

15. The non-transitory computer-readable medium of claim 13, wherein the program factor comprises a rule specifying a calculation for quantifying a transaction benefit.

16. The non-transitory computer-readable medium of claim 13, wherein the program factor comprises a rule specifying a buying frequency criterion for qualifying for a purchase transaction benefit.

17. The non-transitory computer-readable medium of claim 13, wherein the program factor comprises a rule requiring multiple products in a purchase transaction.

18. The non-transitory computer-readable medium of claim 13, wherein the program factor comprises a rule based on consumer demographic information.

19. The non-transitory computer-readable medium of claim 13, wherein the instructions to determine the fund amount include further instruction to determine the fund amount based on an available consumer account balance.

20. The non-transitory computer-readable medium of claim 13, the instructions comprising further computer code to store data indicative of the purchase transaction in a transaction history database, and wherein the instructions to determine the fund amount include further instructions to analyze past transaction data stored in the transaction history database regarding a previous purchase transaction involving the consumer.

21. The non-transitory computer-readable medium of claim 13, the instructions comprising further computer code to transfer funds by:
debiting a settlement account associated with the manufacturer or a payment card in an amount that corresponds with the determined fund amount;
crediting a settlement account associated with a merchant, a charity or an individual in an amount that corresponds with the determined fund amount; and
recording the settlement transactions in a funds settlement database.

22. A system for facilitating a purchase transaction between a consumer and a merchant for a plurality of products, a respective product of which is associated with a manufacturer, the system comprising:
a merchant data collection system configured to obtain product information regarding the plurality of products during the purchase transaction and to further obtain a consumer account code for the consumer and a manufacturer identification code for the manufacturer via an instrument presented by the consumer to the merchant during the purchase transaction;
a merchant processing system comprising:
a filter module configured to identify the respective product of the plurality of products by filtering the product information based on the manufacturer identification code to generate a filtered list of the plurality of products;
an authorization request and response module configured to generate, for transmission via a communication network, an authorization request message comprising the consumer account code, the manufacturer identification code, the filtered list of the plurality of products comprising a product identification code for the respective product, and pricing data for the respective product, and being further configured to receive an authorization response message comprising a fund amount or a discount to be applied in connection with the purchase transaction; and
a funds module configured to apply the fund amount or the discount in connection with the purchase transaction;
a memory in which program data is stored, the program data specifying program rules, criteria and factors for the manufacturer; and
a manufacturer agent processing system in communication with the memory and in communication with the merchant processing system via the communication network to receive the authorization request message, the manufacturer agent processing system being configured to determine the fund amount or the discount to be applied in connection with the purchase transaction based on the program data and data in the authorization request message, and being further configured to send an authorization response message during the purchase transaction to the merchant via the communication network regarding application of the determined fund amount.

23. The system of claim 22, wherein the instrument is a loyalty card for one or more manufacturers.

24. The system of claim 22, wherein the instrument is a payment card configured for purchase only of products from the manufacturer.

25. The system of claim 22, wherein the manufacturer agent system stores consumer demographic data, and wherein the manufacturer agent processing system is further configured to analyze the demographic data in determining the fund amount or the discount to apply in connection with the purchase transaction.

26. The system of claim 22, wherein the manufacturer agent system comprises a transaction history database in which data indicative of the purchase transaction is stored, and wherein the manufacturer agent processing system is further configured to analyze past transaction data stored in the transaction history database regarding a previous purchase transaction involving the consumer.

27. The system of claim 22, wherein the manufacturer agent system comprises a funds settlement database in which data indicative of transferring funds related to the purchase transaction is stored, and wherein the manufacturer agent processing system is further configured to:
debit a settlement account associated with the manufacturer or a payment card in an amount that corresponds with the fund amount in connection with the purchase transaction;
credit a settlement account associated with a merchant, a charity or an individual in an amount that corresponds with the fund amount applied in connection with the purchase transaction; and
record the settlement transactions in a funds settlement database.

28. The system of claim 22, further comprising a manufacturer program system configured to facilitate a consumer selection of one or more manufacturer preference programs, products of a specific manufacturer, or an instrument type.

29. The system of claim 22, further comprising a manufacturer program system operable to configure program factors applicable to authorization requests from a plurality of merchant systems.

30. The system of claim 22, wherein the program data includes a plurality of rules, the plurality of rules including a demographic rule, a historical transaction rule, a current transaction rule, and an account information rule.
